(19) United States
(12) Patent Application Publication
(10) Pub. No.: US 2011/0029339 A1
(43) Pub. Date: Feb. 3, 2011

(54) Enterprise and Sales Management Platform

(75) Inventor: Joseph M. Callahan, Bryn Mawr, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: CIRIGHT SYSTEMS, INC, Bryn Mawr, PA (US)

(21) Appl. No.: 12/533,648

(22) Filed: Jul. 31, 2009

(51) Int. Cl. G06Q 10/00; G06F 17/30; G06Q 30/00

(52) U.S. Cl. 705/7; 707/E17.009; 707/E17.045

(57) ABSTRACT

Systems and methods that perform one or more enterprise management and/or sales operations according to a selected player chain strength paradigm are provided. In an illustrative implementation, an enterprise management and sales environment comprises a computer implemented enterprise management and sales engine having a processor executing one or more instructions, and an instruction set comprising at least one instruction to process data representative of a sales/project opportunity according to a selected player chain strength paradigm. Illustratively, the enterprise management and sales engine can cooperate with an advertising engine to identify one or more advertisements for electronic communication to one or more users and a sales assistant engine to generate one or more sales/project opportunities action item lists using one or more generated sales/project management processed data sets and data about a user of the enterprise management and sales environment.

### BACKGROUND

Enterprise resource management and planning (enterprise resource management—ERM and enterprise resource planning—ERP) has become tantamount to the success of an organization. Within an organization, hand in hand with ERM and ERP efforts, are coordinated project management and sales management initiatives that promote shorter sales cycles, higher probability of successful sales activities, and overall revenue growth of an organization. In the context of sales management, customer relationship management (CRM) processes can be deployed that provide insight into a customer's needs, affinities, and characteristics so as to more efficiently, optimally, and repeatedly achieve successful sales for an organization.

Current practices leverage various applications that address, in part, ERM, ERP, and CRM needs of organizations. Such applications generally operate independent of each other and do not communicate efficiently together, which often results in users inputting similar or identical information more than once for each of the utilized ERM, ERP, and/or CRM applications. Additionally, such applications do not similarly process required inputted data to perform the desired ERM, ERP, and/or CRM operations. Stated differently, since each of the utilized applications are generally designed independent of each other, their respective data models are different which forecloses the availability to have a single data input direct the performance of a desired CRM/ERP combination operation.

An organization wishing to perform integrated ERM, ERP, and/or CRM operations, with current practices, will be required to license-in one or more ERM, ERP, and/or CRM applications that generally, under current practices, are not fully integrated. Additionally, the organization can be required to license-in additional complimentary computing applications such as an accounting application, employee management application, word processing application, and spreadsheet application to handle additional administrative tasks and/or generate required administrative deliverables in support of successfully closing a sales/project opportunity. Moreover, with current practices, the organization personnel are often left to re-input similar or identical data across one or all of these computing applications to perform desired ERP, ERM, CRM, word processing, spreadsheet (e.g., forecasting and trending), accounting, and/or employee management operations. Further, any ERP, ERM, CRM, word processing, spreadsheet, accounting, and/or employee management data that is generated by such applications is not generally shared among or between these non-integrated computing applications.

Hence, generated data from the a first enterprise application (e.g., CRM) which could be beneficial in defining one or more constraints for another application or desired operation (e.g., ERP) is generally not electronically shared and/or integrated with current practices and thus such generated data from the first application has to be interpreted by organization personnel for re-inputting into a second application.

Furthermore, in addition to the lack of data integration, existing ERM, ERP, and CRM applications are simply lacking in functionality. Existing ERM, ERP, and CRM applications tend to be one dimensional and designed to provide a limited set of functionality. Existing applications fail to leverage the rich data set that is accumulated by ERM, ERP, and CRM applications to provide enhanced functionality.

### SUMMARY

Applicants disclose systems and methods that perform one or more enterprise management and/or sales management operations according to a selected player chain strength paradigm.

In an illustrative implementation, an enterprise management and sales environment comprises a computer implemented enterprise management and sales engine having a processor executing one or more instructions, and an instruction set comprising at least one instruction to process data representative of a sales/project opportunity according to a selected player chain strength paradigm to generate one or more sales/project management processed data sets representative of one or more characteristics of a sales/project opportunity. In an illustrative implementation, the enterprise management and sales environment can further comprise an advertising engine cooperating with the enterprise management and sales engine to identify one or more advertisements for electronic communication to one or more users of the enterprise management and sales environment according to a selected advertising selection paradigm. In the illustrative implementation, the exemplary advertising selection paradigm can comprise at least one instruction to select one or more advertisements using a weighting/affinity selection algorithm and data representative of the one or more users of the enterprise management and sales environment.

In an illustrative operation, the enterprise management and sales engine can process data representative of one or more users of the enterprise management and sales environment to provide access to the one or more users to selected enterprise management and sales environment data. In the illustrative operation, a user having access to selected data can engage a request for the selected data through an exemplary communications mechanism (e.g., a hyperlink in an e-mail). Responsive to the request for the access provided selected data, the enterprise management and sales engine can cooperate with the advertising engine to provide data representative of the user requesting the selected content to the advertising engine. In the illustrative operation, the user data can be operatively used by the advertising engine to select one or more advertisements, provided by one or more parties desiring to reach a selected user demographic through an advertisement defined by one or more targeted advertising criteria, using a selected affinity/weighting selection algorithm.

In an illustrative implementation, the enterprise management and sales environment can further comprise a sales assistant engine cooperating with the enterprise management and sales engine to generate one or more sales/project opportunities action item lists using one or more generated sales/project management processed data sets and data about a user of the enterprise management and sales environment.

In an illustrative operation, the sales assistant engine can electronically communicate through an exemplary communications interface (e.g., interactive voice recognition) the one or more generated sales/project opportunities action item lists to one or more users (e.g., sales persons) and can illustratively through one or more automated voice prompts prompt the one or more users to complete one or more action items of the generated sales/project opportunities action item list. In the illustrative operation, the sales assistant engine can operatively receive data inputted through the exemplary communications interface representative of status of one or more action items of the generated sales/project opportunities action item lists.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an exemplary computing environment in accordance with an illustrative implementation of the herein described systems and methods.

FIG. 2 is a block diagram of an exemplary networked computing environment in accordance with an illustrative implementation of the herein described systems and methods.

FIG. 3 is a block diagram showing the cooperation of exemplary components of an illustrative implementation in accordance with the herein described systems and methods.

FIG. 4 is a block diagram showing an illustrative block representation of an illustrative implementation of an exemplary enterprise management environment in accordance with the herein described systems and methods.

FIG. 5 is a block diagram describing illustrative one or more relationships between cooperating parties of an exemplary project in accordance with the herein described systems and methods.

FIG. 6 is a block and flow diagram of illustrative stages of a an exemplary project in accordance with the herein described systems and methods;

FIG. 7 is a block flow diagram of illustrative cooperation between cooperating components of an exemplary enterprise management/sales/advertising platform environment in accordance with the herein described systems and methods; and

FIG. 8 is a block diagram of illustrative cooperation between processing components of an exemplary enterprise management/sales/advertising platform environment in accordance with the herein described systems and methods;

FIG. 9 is a diagram of an illustrative graphical user navigation interface of an exemplary enterprise management/sales/advertising platform environment in accordance with the herein described systems and methods;

FIG. 10 is a screen shot of an exemplary graphical user interface of an exemplary enterprise management/sales/advertising platform environment in accordance with the herein described systems and methods;

FIG. 11 is a screen shot of an exemplary graphical user interface of an exemplary enterprise management/sales/advertising platform environment in accordance with the herein described systems and methods;

FIG. 12 is a screen shot of an exemplary graphical user interface of an exemplary enterprise management/sales/advertising platform environment in accordance with the herein described systems and methods;

FIG. 13 is a screen shot of an exemplary graphical user interface of an exemplary enterprise management/sales/advertising platform environment in accordance with the herein described systems and methods;

FIG. 14 is a screen shot of an exemplary report generated by an exemplary enterprise management/sales/advertising platform environment in accordance with the herein described systems and methods;

FIG. 15 is a screen shot of an exemplary trend graphical report generated by an exemplary enterprise management/sales/advertising platform environment in accordance with the herein described systems and methods;

FIG. 16 is a block diagram of illustrative cooperation between cooperating components of an exemplary enterprise management/sales/advertising platform environment utilizing a virtual sales assistant in accordance with the herein described systems and methods;

FIG. 17 is a flow diagram of illustrative processing performed to manage enterprise sales/project data by an exemplary enterprise management/sales/advertising platform environment in accordance with the herein described systems and methods;

FIG. 18 is a flow diagram of illustrative processing performed by an exemplary enterprise management/sales/advertising platform environment in accordance with the herein described systems and methods;

FIG. 19 is a flow diagram of illustrative processing performed when integrating advertising in enterprise content provided to one or more cooperating players by an exemplary enterprise management/sales/advertising platform environment in accordance with the herein described systems and methods; and

FIG. 20 is a flow diagram of illustrative processing performed when integrating advertising in enterprise content provided to one or more cooperating players by an exemplary enterprise management/sales/advertising platform environment in accordance with the herein described systems and methods.

### DETAILED DESCRIPTION OF ILLUSTRATIVE EMBODIMENTS

### Illustrative Computing Environment

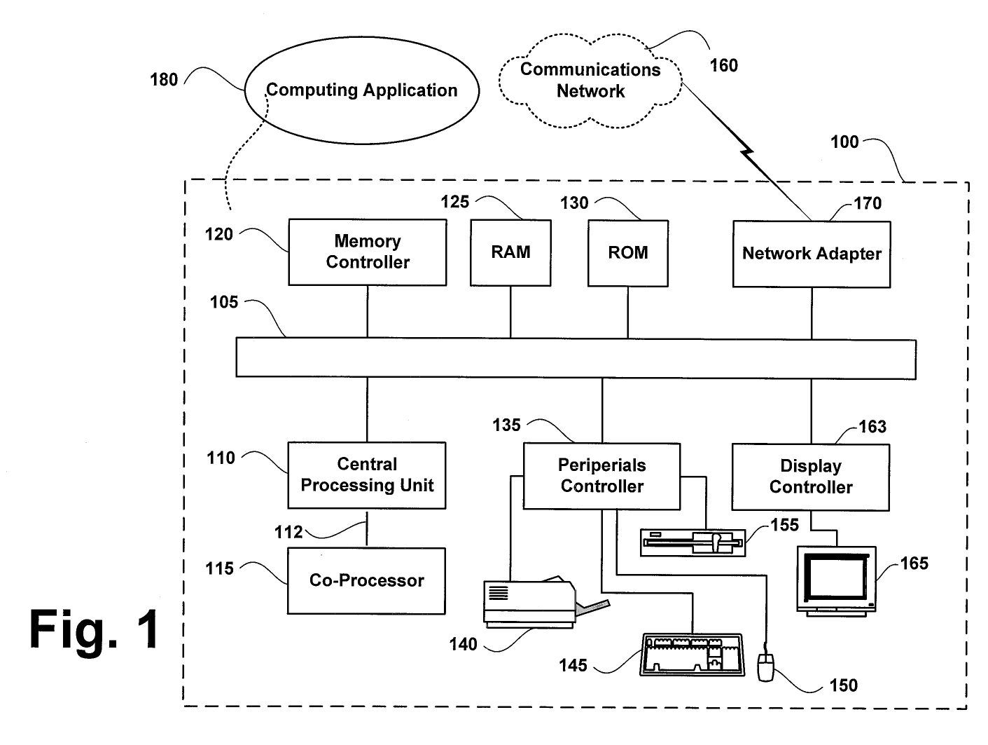

FIG. 1 depicts an exemplary computing system 100 that may be used to implement various aspects of the herein described system and methods. For example, computing system 100 may be adapted for use in implementing the data management systems and methods that are described below. Referring to FIG. 1, the computing system 100 is capable of executing a variety of computing applications 180. Computing application 180 may comprise, for example, a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to operate. In many known computer servers, workstations and personal computers CPU 110 is implemented by micro-electronic chips CPUs called microprocessors. A coprocessor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, audio, and video. The display controller 163 includes electronic components required to generate a video signal that is sent to display 165. Further, the computing system 100 can contain network adaptor 170 which may be used to connect the computing system 100 to an external communication network 160.

### Illustrative Computer Network Environment:

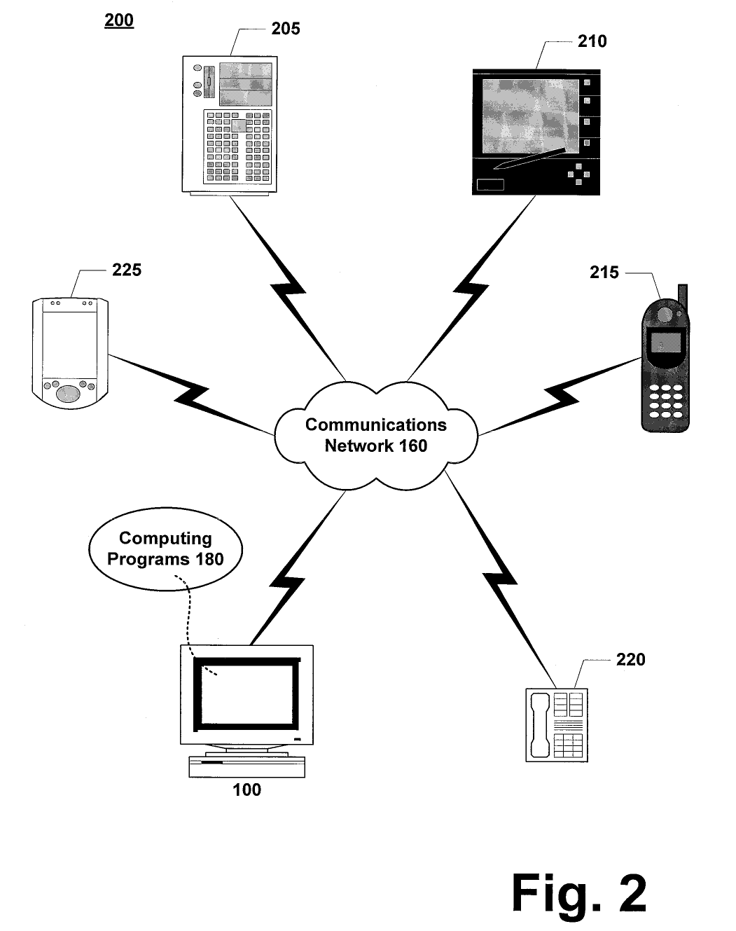

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed.

As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments. In connection with the herein described systems and methods, server 205 may be employed, for example to provide content management and distribution services as described below. Client computing environments may comprise devices such as tablet personal computer 210, mobile telephone 215, telephone 220, personal computer 100, and, personal digital assistant 225 In connection with the herein described systems and methods, server 205 may be employed, for example, to provide enterprise management, project opportunity identification and reporting, digital assistant services, and advertisement distribution services as described herein.

In a network environment in which the communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 220, and 225 can be equipped with operating system 180 operable to support one or more computing applications, such as a web browser (not shown), or other graphical user interface (not shown), or a mobile desktop environment (not shown) to gain access to server computing environment 205.

During operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

### Enterprise Data Management:

Applicants disclose systems and method that employ the strength of relationships between players, i.e. parties or entities that are associated with projects, to identify and derive data regarding various projects and opportunities associated with the projects.

While the disclosed systems and methods are not limited to use with any one industry or scenario, the construction industry presents a useful context to explain aspects of the disclosed systems and methods. A construction project presents sales opportunities for vendors that might wish to provide services or products in connection with the project. For example, a construction project represents an opportunity for electrical contractors to obtain a contract to provide electrical contracting services and an opportunity for heating and for ventilation equipment providers to obtain a contract to provide the heating and ventilation equipment. In an illustrative scenario, the strength of the relationships between vendors such as electricians and lighting equipment manufacturers with other parties, such as architects, construction managers, and general contractors, may be used to determine what data regarding sales opportunities should be presented to the vendor. For example, in an illustrative embodiment where a consulting engineer has been selected to work with an architect to prepare specifications for a building project, the disclosed systems might identify the relationship between the consulting engineer and architect to a manufacturing representative that wishes to have his product specified for use on the job. The system may further suggest that the manufacturing representative contact the consulting engineer and thereby enhance the probability of having his product included in the specifications.

In an exemplary embodiment, a system may comprise a data store comprising data regarding one or more opportunities and data regarding one or more parties associated with the one or more opportunities. For example, in a construction industry scenario, the data store may comprise data regarding specific construction projects and the various vendors and contractors that are associated with the projects. An exemplary engine or system may be programmed to process the data regarding one or more opportunities and the data regarding one or more parties associated with the one or more opportunities to identify parties associated with each of the one or more opportunities. For example, a system may process the data in the data store to identify the particular vendors, contractors, consultants, etc. that are associated with each of the projects. The system may then identify relationships between the identified parties for each of the one or more opportunities, and for each of the identified relationships identify a relationship strength. For example, in the construction project scenario, the system may identify that a consulting engineer provides input to the project architect regarding product to be used on the project, and may further identify that this relationship is relatively strong in terms of the ability of the consulting engineer to impact the selections made by the architect. The system may employ the identified relationship strength for each of the identified relationships to derive data for presentation regarding each of the one or more opportunities. For example, referring to the construction industry scenario, the system may bring to a product vendor's attention that the relationship between the consulting engineer and the architect may be useful in attempting to have the vendor's product specified for use on a particular construction project and may suggest contacting the consulting engineer.

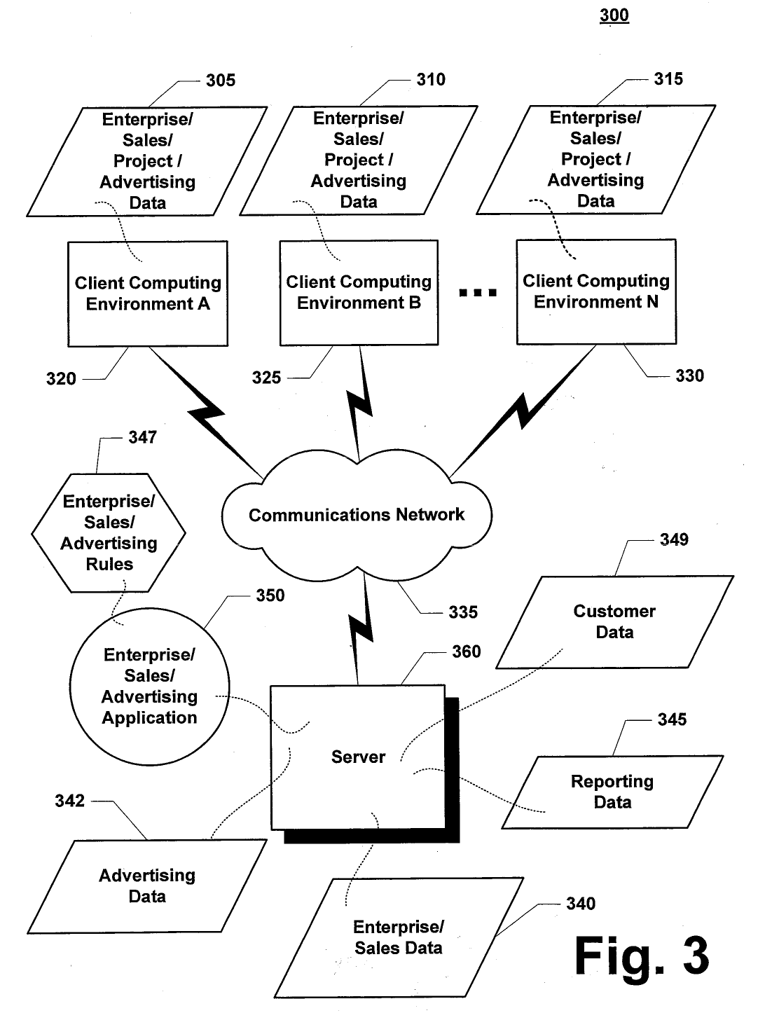

FIG. 3 shows an illustrative implementation of exemplary enterprise data management environment 300 that is suitable for implementing the disclosed methods. Referring to FIG. 3, exemplary enterprise data management environment 300 comprises client computing environment A 320, client computing environment B 325, up to and including client computing environment N 330. Client computing environments 320, 325, and 330 can operatively receive and present for viewing, navigation, modification, and input various enterprise, sales, and advertising data 305, 310, 315, respectively, that may be received via communications network 335 from server computing environment 360. Enterprise, sales, and advertising data 305, 310, 315 may be any information that may be displayed, viewed, electronically transmitted, searched, copied, retrieved, annotated, navigated, and printed from client computing environments 320, 325, and 330, respectively. In an illustrative embodiment, enterprise, sales, and advertising data 305, 310, 315 may comprise, for example, data regarding sales and/or project opportunities, data regarding tasks or activities that require attention, data regarding sales leads, advertising data, enterprise management data, etc. For example, data presented to a user at environments 320, 325, and 330 may comprise an action item listing parties that should be contacted in connection with one or more sales opportunities.

Data is communicated between client computing environments 320, 325, and 330 and server computing environment 360 via communications network 335. Illustratively, communication network 335 can comprise any communications technologies suitable for communicating electronic data including, for example, WAN, LAN, internet, wire line, and wireless technologies.

Server computing environment 360 is operative to execute enterprise/sales/advertising application 350 applying enterprise sales/advertising rules 347. Additionally, server computing environment 360 is further adapted to process, store, and communicate various data (e.g., using enterprise sales/advertising application 350) including but not limited to advertising data 342, enterprise/sales data 340, reporting data 345, and customer 349. In an illustrative operation, one or more client computing environments 320, 325, and/or 330 can provide a request to retrieve or store enterprise management/sales/advertising data 305-315 to enterprise/sales/advertising application 350 executing on server computing environment 360 over communications network 335. Responsive to the request, enterprise/sales/advertising application 350 can process various data including but not limited to enterprise/sales data 340, advertising data 342, customer data 349, and reporting data 345 according to one or more enterprise/sales/advertising rules 347.

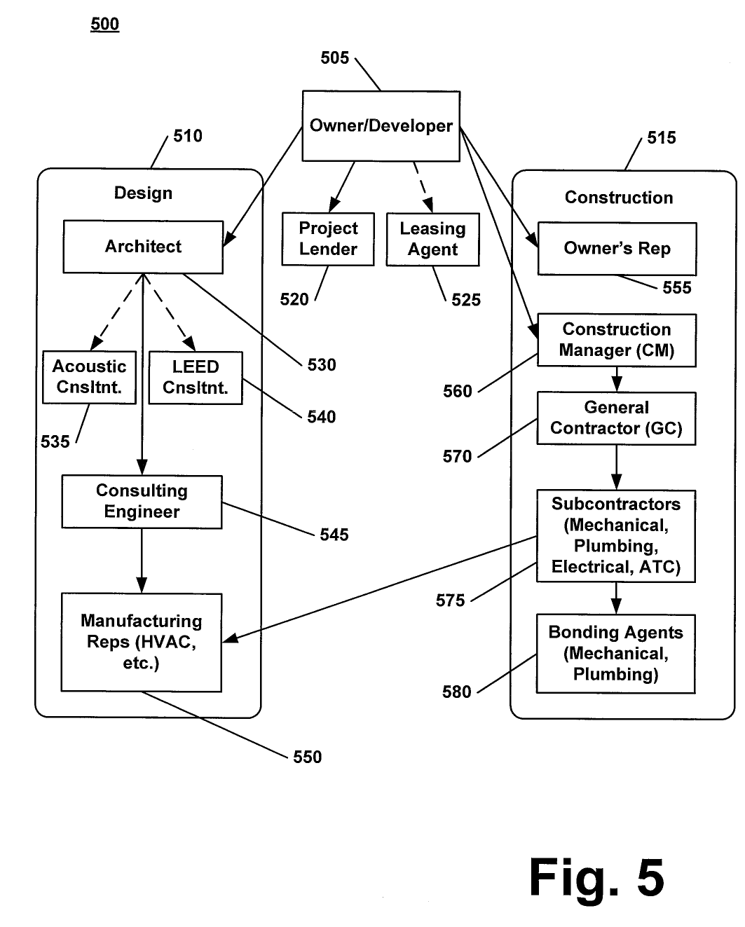

In an illustrative implementation, enterprise/sales data 340, advertising data 342, reporting data 345, and customer data 349 comprises any data that may be used in operation of a computing environment as described herein. Enterprise/sales data 340 may comprise, for example: sales/project opportunities data specifying, for example, projects that are of interest; customer contact data specifying, for example, the customers associated with particular projects; player description data specifying, for example, players or entities associated with a project opportunity; employee data specifying, for example, the particular employees that are associated with a particular project; manufacturer data specifying, for example, manufacturers associated with particular projects; administrative enterprise data; accounting data; enterprise/sales/advertising tracking data; customer relationship data specifying, for example, relationships between parties and an assigned strength for the relationships; enterprise resource management data, enterprise resource planning data, advertiser data, and advertisement content data. Advertising data 342 may comprise any data relating to providing suitable for use in serving advertisements according to the procedures described herein. For example advertising data 342 may comprise, for example: advertisement content data; and information outlining characteristics of the desired target player for the particular advertisement content. Customer data 349 may comprise any data relating to players or customers associated with sales or project opportunities. For example, customer data 349 may comprise, for example: identifier and contact information for each party or player; identification of the employees or contacts for each player; background information regarding each player; background information regarding each employee or contact at a player; etc. Reporting data 345 comprises any report related data that is suitable for use in a system as described herein. For example, reporting data 345 may comprise In an illustrative operation, a participating user (e.g., enterprise sales personnel and/or a player as described by FIG. 5) (not shown) can utilize client computing environment 305 to input and/or retrieve various enterprise/sales/advertising (and/or processed enterprise/sales/advertising data) from enterprise/sales/advertising application 350 over communications network 335.

Enterprise/sales/advertising application 350 is adapted to perform processing according to party relationship strength analysis as described herein. For example, application 350 is adapted to automatically process data (e.g., enterprise data 340 and customer data 349) to identify parties associated with project opportunities, to identify relationships between parties for project opportunities, to identify the strengths of relationships between parties, and to use the data regarding the strength of relationships to generate action items regarding opportunities. Application 350 may be further adapted to select advertisements from advertising data 342 depending upon characteristics of a party which may be stored, for example, in customer data 349, and to embed the advertisements in data served to the party. Application 350 is programmed to generate reports relating to all aspects of the operation of enterprise management platform 300. For example, reports and the associated reporting data 345 may be generated relating to the usage of enterprise/sales/advertising data 305, 310, and 315 by which participating user (not shown), the delivery of enterprise/sales/advertising data 305, 310, and 315 to one or more participating players (not shown), generated trending data (e.g., generated by enterprise/sales/advertising application 350) regarding sales/project opportunities (and/or completed projects), sales efficiency reporting data, and sales compensation reporting data.

Enterprise/sales/advertising rules 347 represent the rules and/or logic that are employed by application 350 to process requests and present data for use at environments 320, 325, and 330. For example, rule 347 represent the logic that determines the list of action items that are appropriate for a particular player. Likewise, rules 347 may comprise the software logic that determines the advertisements that correspond to the characteristics associated with a particular player contact or user.

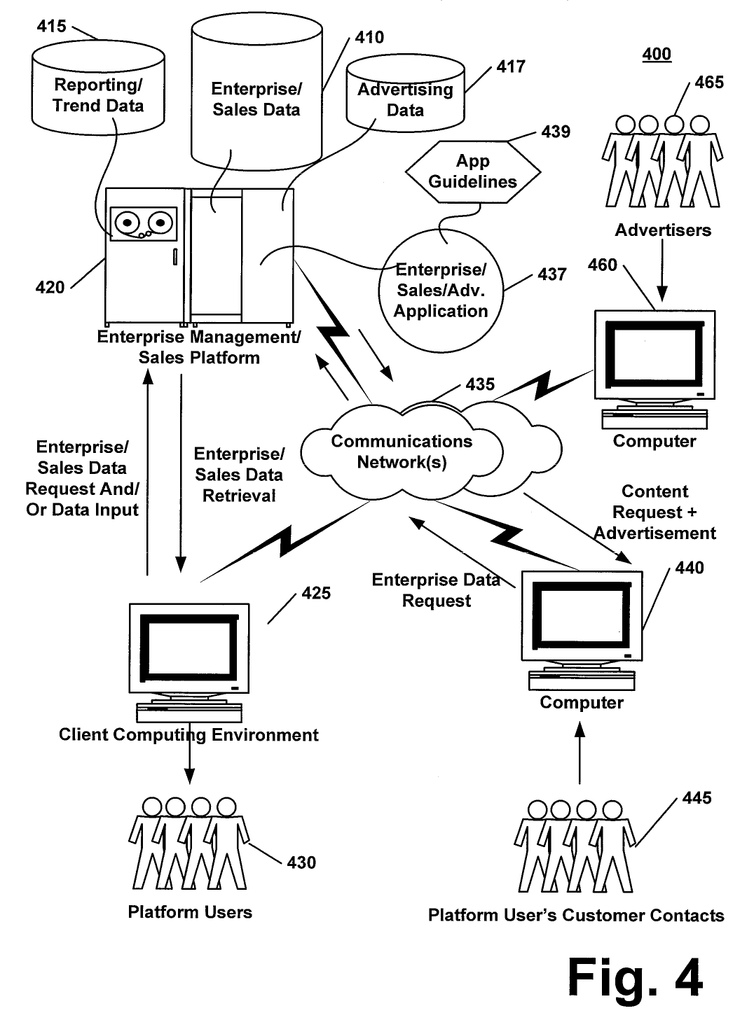

FIG. 4 provides a view of an illustrative implementation of an exemplary enterprise management environment 400. The description of the functional components above in connection with FIG. 3 generally applies to and maps to the components depicted in FIG. 4. Enterprise management/sales platform 420 has access to enterprise/sales data 410, reporting/trend data 415, and advertising data 417. Enterprise/sales/advertising application 437 can be, in an illustrative implementation, a software application that executes on enterprise management/sales platform 420 and can apply enterprise management/sales application guidelines 439 to various data including but not limited to enterprise/sales data 410, reporting/trend data 415, and advertising data 417. In an exemplary embodiment, enterprise management/sales application guidelines 439 may reflect one or more player relationships as described in FIG. 5. In an alternate embodiment, one or more of the various data that enterprise management/sales platform 420 utilized can be stored separately from enterprise management/sales platform 420.

Enterprise management/sales platform 420 is communicatively coupled to client computing environment 425 (e.g., operative by one or more participating users 430—e.g., enterprise sales personnel) via communications network 435. In an illustrative embodiment, communications network 435 may comprise fixed-wire and/or wireless intranets, extranets, local area networks, wide area networks, and the Internet.

In an illustrative operation, one or more participating users 430 (e.g., enterprise sales personnel) can request and/or input various enterprise/sales data to enterprise management/sales platform 420 using client computing environment 425 over communications network 435. Responsive to the request to retrieve/store enterprise/sales data, enterprise management/sales data can execute enterprise/sales/advertising application 437 applying one or more enterprise/sales/advertising application guidelines 439 to retrieve/store selected enterprise/sales data and communicate enterprise/sales data to client computing environment 425 over communications network 435 for viewing, navigation, storage, appending, modification, etc. by one or more participating users 430.

Further, as is shown in FIG. 4, enterprise management environment 400 can comprise advertising computing environment 460 communicatively coupled to enterprise management/sales platform 420 over communications network 435, and customer computing environment 440 that is communicatively coupled to enterprise management/sales platform 420 over communications network 435. In the illustrative implementation, enterprise/sales/advertising application 437 executing on enterprise management/sales platform 420 can cooperate with advertiser computing environment 460 over communications network 435 to receive data representative of one or more selected advertisements. In an illustrative embodiment, the advertisement data may be selected by advertiser computing environment 460 using one or more characteristic data of a customer to whom, illustratively, access may be provided to access various data from enterprise management/sales platform 420. The characteristic data can be operatively communicated by enterprise management/sales platform 420 to advertiser computing environment 460. The advertising data is processed at platform 420 and may be integrated with various enterprise sales data that can be delivered to customer computing environment 440 over communications network 435 for viewing, navigation, and/or modification by customer computing environment customers 445.

In an illustrative operation, one or more customers can be provided access to various selected enterprise project data 410 by enterprise management/sales platform 420 executing enterprise/sales/advertising application 437. For example, parties may be provided with an action item list identifying opportunities that have been identified for the particular party using a player relationship strength analysis. In an exemplary scenario wherein the disclosed systems and methods are applied to the construction industry, during the period of time between when a project is first conceived until a contract for project is awarded, there may be opportunities to contact parties that have the ability to influence a positive outcome for a particular vendor. It may benefit the vendor to contact the appropriate parties for any reason that might enhance a positive outcome. For example, it might be useful to contact the party to request that the vendor be given the work. In another instance, it may be beneficial for a vendor to contact a party to request that the party contact the decision maker on the vendor's behalf and in support of the vendor's proposal to obtain the contract. Accordingly, in an exemplary environment, an action item list may be generated identifying for a first project opportunity, the name of the general contractor that has been awarded a building contract and an action item to contact the general contractor to request confirmation of a subcontract. The action item list may also identify for a second project opportunity the name of the architecture firm that is preparing the specifications for the new building project and an action item to contact the consulting engineer that is working with the architect in order to propose that a particular vendor's product be included in the specifications.

The project data 410, which may include an action item list, may be communicated to the user or customers 445 at computing environment 440 via any suitable means. For example, an email may be communicated to the user. The email may comprise a hyper-link to a web page, which when activated by the user causes a request for the corresponding information to be made available to the user at computing environment 440. In an illustrative embodiment, enterprise/sales/advertising application 437 can apply one or more application guidelines 439 to integrate the selected advertisement (e.g., illustratively selected by advertiser computing environment 460) into various project data 410 and communicate the advertisement laden project data to customer computing environment 440 for viewing and navigation by one or more customers 445.

Enterprise management environment 400 may be used in any suitable context to identify and provide data regarding project opportunities. In one exemplary embodiment, the environment may be used, for example, in the context of the construction industry. FIG. 5 is a block diagram of an exemplary player relationship definition 500 for an exemplary construction project. Player relationship definition 500 illustrates relationships between various players or entities that might participate in or in some way be associated with a construction project. The strength of relationships between players or entities associated with a construction project may be utilized by exemplary enterprise management/sales platform 420 and enterprise/sales/advertising application 437 of FIG. 4 to identify opportunities for parties in connection with a construction project.

As is shown in FIG. 5, in an illustrative embodiment, player relationship definition 500 comprises the following players: owner/developer 505, architect 530, acoustic consultant 535, LEED consultant 540, consulting engineer 545, manufacturing reps 550, project lender 520, leasing agent 525, owner's rep 555, construction manager (CM) 560, general ctor (GC) 570, subcontractors (e.g., mechanical, plumbing, electrical, ATC) 575, and bonding agents (mechanical, plumbing, etc.) 580. Each of the players might contribute to the project in some manner. The owner 505 is the person or organization that owns the property or building in connection with the project is being undertaken. An owner 505 in some circumstances might be a developer. The project lender 520 is typically a bank or bonding agency that provides money for construction of a building. A leasing agent 525 might work for the owner/developer 505 and be tasked with finding tenants and handle leasing duties. The architect 530 typically creates detailed plans and drawings for a building or construction project at the request of the owner. An acoustic engineer 535 provides advice, typically to architect 530, regarding sound qualities for rooms of a building. For example, the acoustic engineer 535 can be used to help reduce sound in school classrooms since studies show that this noise reduction improves learning. A leadership in energy and environment design (LEED) consultant 540 typically advises the architect 530 on how to design a building that is energy efficient (e.g., green). The consulting engineer 545 provides electrical, mechanical, and plumbing advice to the architect 530, typically when the architectural plans for the project are being created. Manufacturing representatives 550 represent manufacturers of building equipment and provide advice to consulting engineers and possibly architects regarding products that are available for use in the project. Once the plans are in place and the project enters a construction phase, the manufacturing rep 550 might sell equipment to a contractors in connection with executing the project and installing equipment.

The owner's representative 555 can serve as a proxy for the owner 505 and has limited authority. For example, he does not have contractual relationships with any other party other than the owner 505. The construction manager 560 plans and coordinates the construction of a building. The general contractor 570 manages the subcontractors on a project and can ensure that the plans of the construction manager 560 are being executed. Subcontractors 575 generally work for the general contractor 570 and are responsible for completing specific portions of the project. For example, automated temperature controls (ATC) subcontractors might install automatic temperature controls systems in a building. Mechanical contractors 575 are responsible for the mechanical components of the building including the HVAC system. Plumbing contractors 575 are typically responsible for the plumbing in a building. The sheet metal contractor 575 can make, install, and maintain heating, ventilation, and air-conditioning duct systems, roofs, siding, and rain gutters. Sheet metal contractors are usually hired by the general contractor, but are sometimes hired by a mechanical contractor 575.

Bonding agents 580 typically bond the work of contractors and subcontractors as a precaution to insure that work will be completed. The value of the bond is forfeited to the owner if the subcontractor does not complete the work or goes out of business.

In the illustrative embodiment of FIG. 5, solid arrows are used to represent established relationships (e.g., an ability of one party to direct influence over) between players. Dashed arrows represent optional relationships between players that may or may not exist depending on the circumstances of the particular project. These player relationships are useful because each represents a point of influence in deploying project 500. The disclosed systems and methods capture these relationships and assign a value to the strength of the relationship or influence provided by the relationship and use the captured data to identify opportunities for parties that are associated with a project such as a construction project.

In the illustrative embodiment of FIG. 5, the owner/developer 505 needs to borrow money from a project lender 520 in order to undertake the project as represented by the solid line between these parties. The owner/developer 505 may use a leasing agent 525 to pre-sell some of the space in the building before construction. The optional nature of the relationship is illustrated by the dashed line.

In an illustrative operation, the owner/developer 505 can discuss project financing with the project lender 520. The owner/developer 505 may be required to commission preliminary drawings created by the architect 530 to show the project lender 520. The developer 505 may work with a leasing agent 525 to pre-sell some of the building space. This pre-sold space can be used as collateral with the project lender 520. From there, the project may enter design phase 510.

In the design phase, the owner/developer 505, if they have not done so previously, hires an architect 530 as illustrated by the line between owner 505 and architected 530. The architect is responsible for preparing detailed plans and drawings for the project.

The architect 530 may hire an acoustic consultant 535 and LEED consultant 540, if necessary. The optional nature of the relationship is represented by dashed lines. The architect 530 can also hire a consulting engineer 545 to help with the building design as represented by the solid line between architect 530 and engineer 545. The consulting engineer 545 obtains advice from manufacturing representative firms 550 on the specific equipment for the building as illustrated by the solid line between these parties. For example, manufacturing representatives 550 might provide advice regarding the specifications for HVAC equipment. The equipment that is specified by the consulting engineer 545 in consultation with the architect 530 will eventually be purchased by the subcontractors 575 during the construction phase 515 of project 500 as represented by the line between 575 and 550.

When a project is in the construction phase 515, the owner/developer 505 can hire the owner's representative 555 and construction manager 560. Solid lines illustrate the influence the owner 505 has over the representative 555 and manager 560. The representative 555 makes sure that the project is being managed in a manner consistent with the owner's 505 expectations. The owner's representative may recommend the construction manager 560 to run the overall project, but the owner/developer 505 makes the hiring decision. The owner's representative then works with the construction manager 560 to make certain that construction manager 560 is acting in the owner/developer's best interest. The construction manager 560 hires a general contractor 570 to build the desired building. The general contractor 570 can hire many types of subcontractors 575 to construct the subsystems of the building in accordance with the plans prepared by architect 530.

Thus, numerous relationships may exist between parties that are associated with or potentially involved in a project such as a construction project. Furthermore, relationships that exist between parties are potential sources of influence over decision making in connection with the project. For example, a consulting engineer 545 has a relationship with architect 530 and provides advice to architect 530 as to the types of equipment that are specified for a project. Accordingly, it might be of interest to manufacturing representatives 550 to communicate with consulting engineer 545 so as to attempt to influence engineer 545 to suggest to architect 530 to use the manufacturers materials on the project. Similarly, a construction manager 560 may have the authority to select a general contractor 570 for a project. Further, the owners rep 555 regularly converses with the construction manager 560 and may be in a position to make suggestions regarding general contractors to construction manager 560. Accordingly, it might be of interest to general contractors to communicate with the owners representative 555 so as to attempt to influence the construction managers 560 selection of a general contractor. The presently disclosed environment captures the relationships between parties in a database such as for example enterprise/sales data 410 and employs the information in identifying opportunities. In an illustrative embodiment, values may be assigned to relationships to represent the strength of influence one party may have on another as a result of the relationship. These values may be input manually into the system or generated automatically based on past experience. The values may be used in prioritizing actions in connection with pursuing an opportunity.

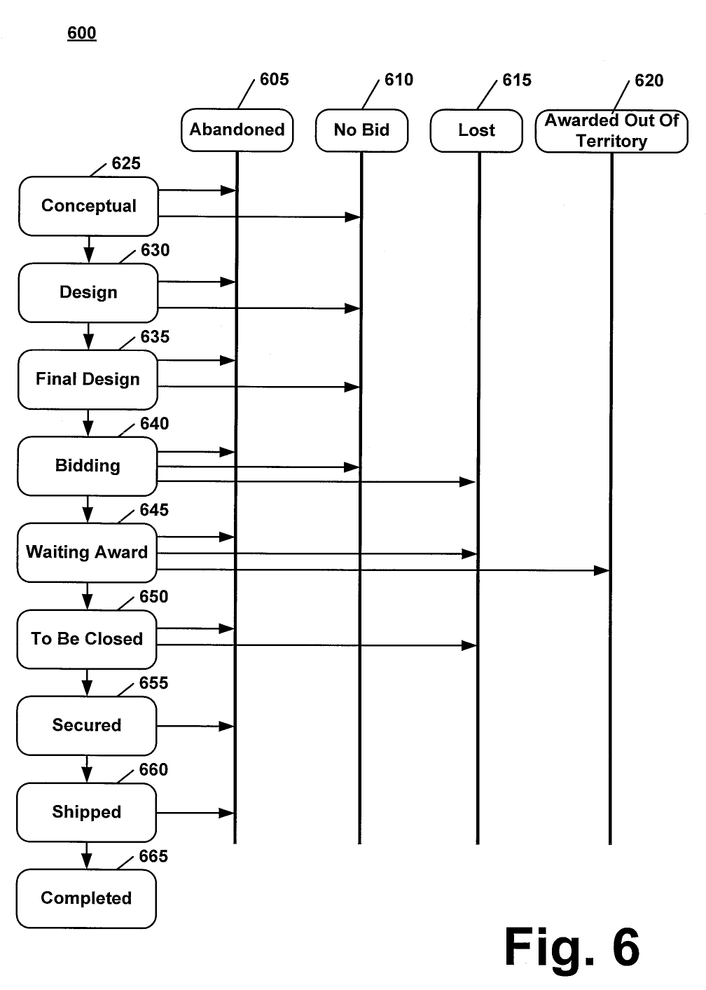

In an illustrative embodiment, the current phase a project is accounted for in connection with analyzing the opportunities available to influence decisions. FIG. 6 depicts a block diagram of exemplary phases and status states of an exemplary project 600 that can be tracked and for which data can be processed by exemplary enterprise management and sales platform 420 of FIG. 4. In an exemplary embodiment, data corresponding to project phases and status states may be captured in, for example, enterprise/sales data 410. As is shown in FIG. 6, an exemplary project might contain a number of project phases including, for example, the following: conceptual 625; design 630; final design 635; bidding 640; waiting award 645; to be closed 650; secured 655; shipped 660; and completed 665. Additionally, the project can enter various status states including, for example, the following: abandoned 605; no bid 610; lose 615; and awarded out of territory 620. In an illustrative implementation, a project can move from one phase to the next. In the illustrative implementation, and as is shown in FIG. 6, exemplary phases are illustrated on the left side on the diagram and can occur as the project moves towards completion. Further, the project status depicted atop the diagram can also change over time. The arrows shown in the figure represent movement from one phase and/or status to another.

In the illustrative implementation, the project phases and/or status can describe various characteristics of exemplary project 600. For example, a project with an abandoned project status 605 can indicate that the project owner has decided not to build or renovate the building. A no-bid project status 610 can indicate that a bid for the project was not submitted. For example, some projects may not merit a bid (e.g., if there is a very low probability of success in winning the bid). A lost project status 615 can indicate that a project was bid and lost to a competitor. An awarded out of territory status 620 can indicate that a bid was put forth for exemplary project 600 by a first user in a first territory but it was awarded to a customer out of the first territory.

A conceptual project phase 625 may indicate that an owner is considering a project to build a new building. A design project phase 630 might indicate that an architect and consulting engineer are working on the design of a building. The final design project phase 635 indicates that contract documents will be completed within a selected period of time (e.g., 90 days) and that the project is prepared to be put out for bid. A bidding phase 640 might indicate that a project design has been completed and final documents for the project have been prepared. The waiting award project phase 645 indicates that the project is pending for an award to a subcontractor. A to-be-closed project phase 650 indicates that a project has been awarded to a contracted party who is in a position to place an equipment order. Consequently, the project owner can published a bid date and time that bids are to be delivered. A secured project phase 655 might indicate that an equipment order has been obtained. The shipped project phase 660 may indicate that some portion of the order has shipped. A completed project phase 665 may indicate that equipment for a project has been shipped and payment has been made for the project equipment.

In an illustrative operation, a project can begin in the conceptual phase 625 and can either proceed to the design phase 630, or be abandoned 605, or a no-bid 610 status can be attached to the project. From the design phase 630, the project can proceed to the final design phase 635, or become abandoned 605, or a no-bid 610 status can be attached to the project. From the final design phase 635, the project can proceed to the bidding phase 640, or become abandoned 605, or a no-bid 610 status can be attached to the project. From the bidding phase 640, the project can proceed to the waiting award phase 645, or become abandoned 605, or a no-bid 610 status can be attached to the project, or the project can be lost 615. From the waiting award phase 645, the project can proceed to the to-be-closed phase 650, or a no-bid 610 status can be attached to the project, or the project can be lost 615, or the project can be awarded out of the territory 620. From the to-be-closed phase 650, the project can proceed to the secured phase 655, or become abandoned 605, or the project can be lost 615. From the secured phase 655, the project can proceed to the shipped phase 660, or become abandoned 605. From the shipped phase 660, the project can proceed to the completed phase 665, or become abandoned 605.

Thus, a project may proceed through various phases and states. Depending upon the phase and status state, the opportunities to influence a potential sale or other project aspect may vary in importance and urgency. For example, when a project is in the design phase 630, there is an opportunity for manufacturing representatives 550 to influence consulting engineers 545 who might influence the architect 530 to include a particular manufacturers devices in the job specifications. However, when the project moves beyond the design and final design 635 phases, there is little opportunity for the consulting engineer 545 to influence the design of the project because the design is complete. However, when the project has reached the bidding phase, the opportunity is ripe for attempting to influence the construction managers 560 and owner's representative 555 as to the selection of a general contractor 570. The illustrative systems and methods capture the logic associated with the impact of changes in phases and status states on the opportunities to influence decision making. This logic and associated data may be stored, for example, in application 437 and application guidelines 439 as well as in enterprise/sales data 410.

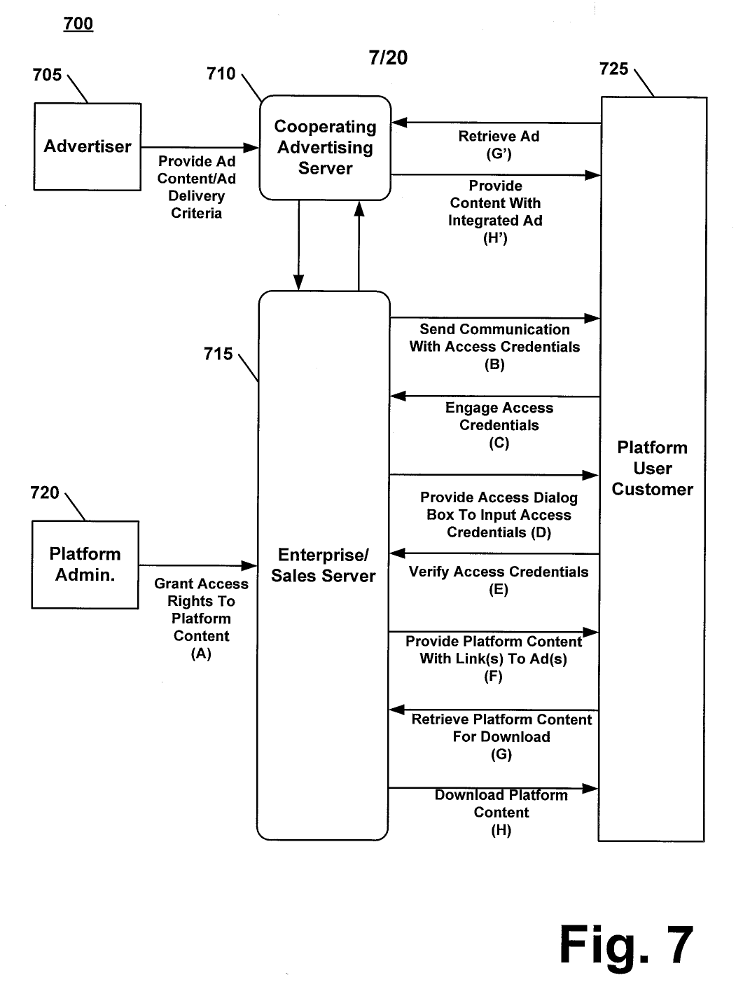

FIG. 7 depicts an exemplary interface between a user platform and one or more cooperating components of an illustrative enterprise management environment 700. The environment 700 is operable to provide access to one or more participating users to enterprise management/sales data and deliver integrated advertisements selected based on one or more characteristics of the participating user to the one or more participating users. As is shown, in an illustrative implementation illustrative enterprise management environment 700 comprises advertisers 705, cooperating advertising server 710, enterprise/sales server 715, platform administrator 720, and platform user customer 725.

In an illustrative operation, access to selected enterprise management/sales data can be provided to one or more platform user customers 725 through a cooperation between platform administrator 720 and enterprise/sales server 715. Once access is authorized by the platform administrator 720, enterprise/sales server 715 can generate and send a communication having the access credentials to the one or more platform user customers 725 that has been provided access. The one or more platform user customers 725 can then engage the access credentials with a communication between the one or more platform user customer 725 and enterprise/sales server 715. A dialog box can then be provided by the enterprise/sales server 715 to the one or more platform user customers 725 (e.g., through a web-based application illustratively operating on a client computing environment to which the one or more platform user customers 725 can engage). The one or more platform user customers 725 can then verify their access credentials by inputting their login credentials (e.g., login credentials provided in the exemplary communication provided to the one or more platform user customers 725 by enterprise/sales server 715) and communicating the inputted login credentials to the enterprise/sales server 715.

In the illustrative operation, platform content (e.g., enterprise management/sales data) with one or more links to activate one or more advertisements (e.g., one or more advertisements that are provided by exemplary advertisers 705 to cooperating advertising server 710 that are served up by enterprise/sales server 715 through a communication between cooperating advertising server 710 and enterprise/sales server 715) can be communicated from enterprise/sales server 715 to one or more platform user customers 725. The one or more platform user customers 725 can then be provided access to retrieve platform content for download from enterprise/sales server 715. In the illustrative operation, the access to retrieve platform content can comprise providing a navigation screen having one or more selected advertisements (e.g. retrieved from the cooperating advertising server 710 for delivery to one or more platform user customers 725) that have been selected for the one or more platform user customers 725 using one or more characteristics of the one or more platform user customers 725. In an exemplary embodiment, characteristics that may be used to identify advertisement content may comprise, for example, data regarding the position (e.g., estimator) a contact holds at an entity, the professional affiliations (e.g., IEEE) of the contact, the educational background (e.g., BS, MA, Phd.) of the contact, and the interests (e.g., golf, running, travel) of the contact. The system may use the characteristic data associated with the individual and/or entity in a weighting or affinity selection algorithm in order to identify advertisements targeted at the contact. The one or more platform user customers 725 can then download platform content for use.

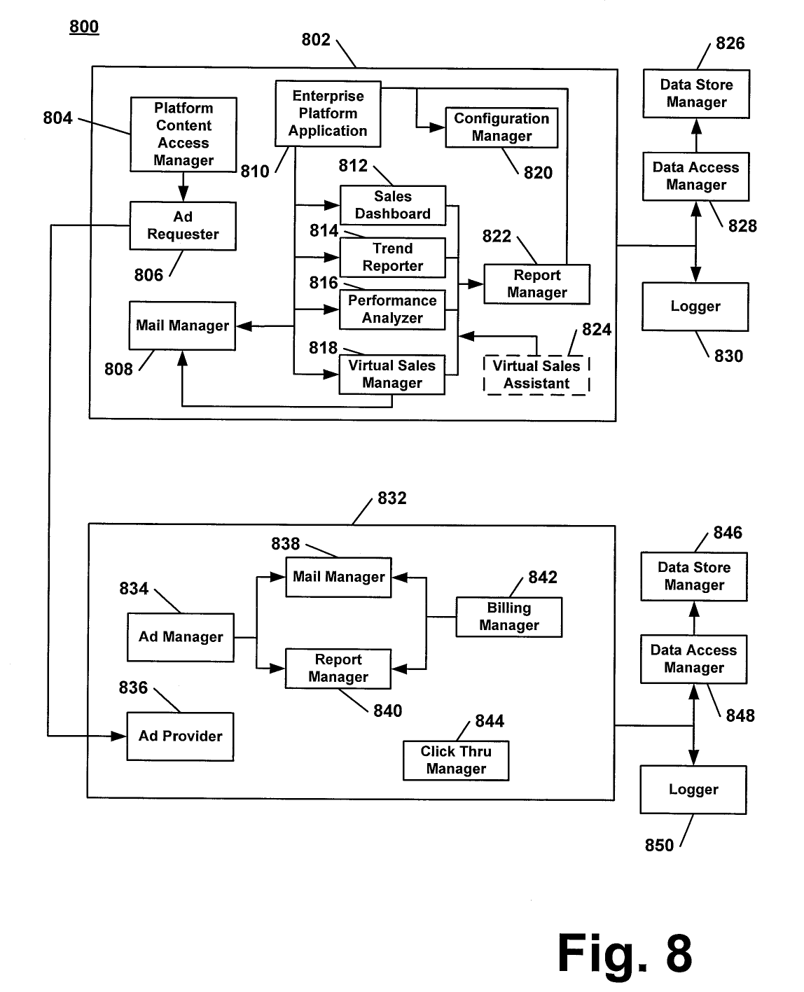

FIG. 8 depicts an illustrative cooperation of various exemplary components of exemplary enterprise management environment 800. As is shown, in an illustrative implementation, exemplary enterprise management environment 800 can comprise exemplary enterprise management and sales platform 802 and advertising computing environment 832. Further, as is shown in FIG. 8, exemplary enterprise management and sales platform 802 can comprise platform content access manager 804, advertisement requester component 806, e-mail manager 808, enterprise platform application 810, sales dashboard 812, trend reporter 814, performance analyzer 816, virtual sales manager 818, configuration manager 820, report manager 822, and virtual sales assistant 824. Further, enterprise management and sales platform 802 can cooperate with data store manager 826, data access manager 828, and logger component 830. In the illustrative implementation, exemplary advertisement computing environment 832 can comprise advertisement manager 834, advertisement provider 836, e-mail manager 838, report manager 840, billing manager 842, click through manager 844. Further, exemplary advertisement computing environment 832 can cooperate with data store manager 846, data access manager 848, and logger component 850.

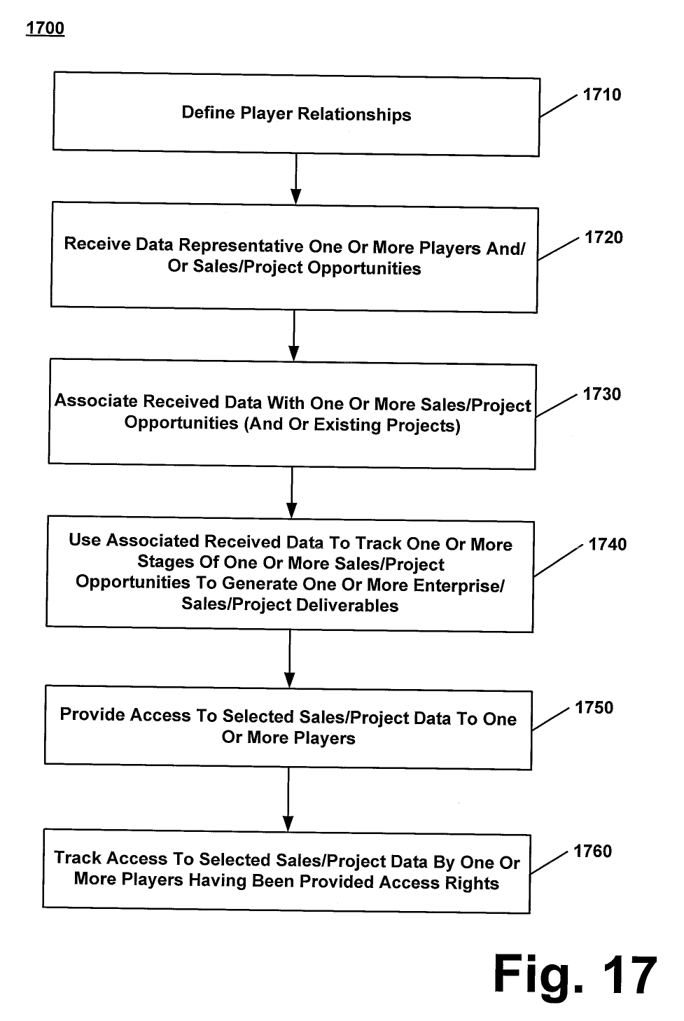

In an illustrative operation, enterprise management and sales platform 802 can communicatively request selected one or more advertisements from advertisement computing environment 832. In the illustrative operation, platform content access manager 804 can selectively provide electronic access to one or more players of an exemplary project (as described by FIG. 5) according to one or more selected criteria including but not limited to an exemplary project's player type to various enterprise management/sales data (not shown). In the illustrative operation, the one or more players having been provided access to the selected data can operatively interface with enterprise management and sales platform 802 through enterprise platform application 810 to retrieve data for download and subsequent use. Enterprise management and sales platform 802 can engage one or more of its components including but not limited to, platform content access manager 804, enterprise platform application 810 and advertisement requester 806 to integrate, through the cooperation with advertisement computing environment 832 (and its components, ad manager 834, e-mail manager 838, report manager 840, advertisement provider 836, billing manager 842, and click through manager 844), one or more advertisements into selected enterprise management/sales data (as described by FIGS. 17, 19, and 20) for communication to one or more access-authorized players.

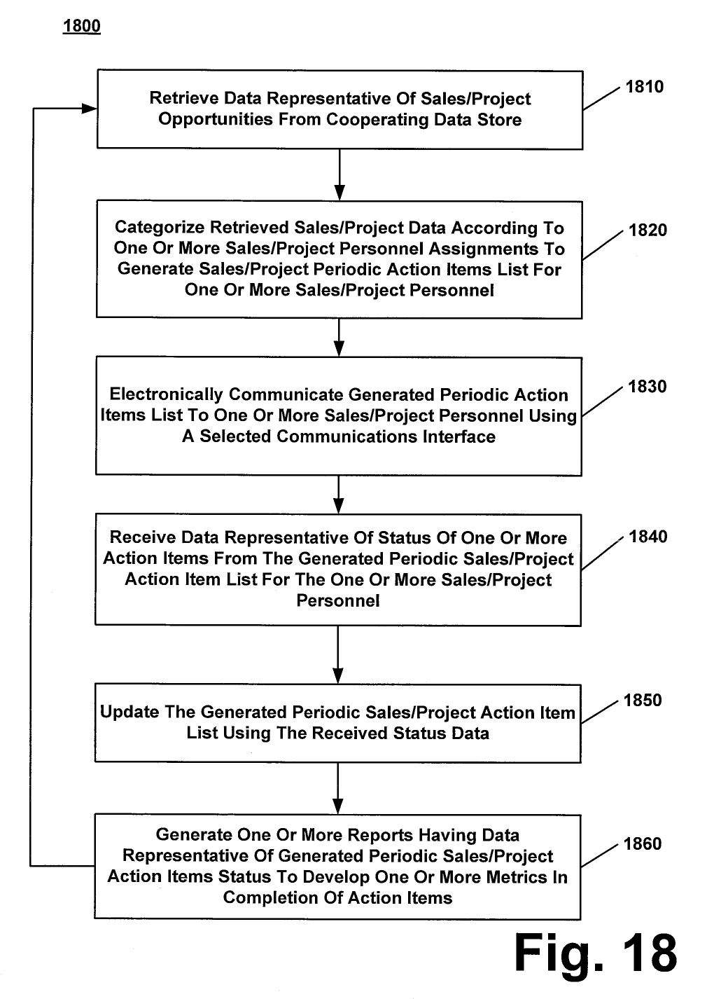

In the illustrative operation, enterprise platform application 810 can operatively perform various enterprise management and sales operations through the cooperation with one or more enterprise management and sales platform 802 components including but not limited to sales dashboard 812, trend reporter 814, performance analyzer 816, and virtual sales manager 818. Additionally, in the illustrative operation, enterprise platform application 810 can cooperate with configuration manager 820 and report manager 822 to perform environment configuration operations and to generate one or more reports. Furthermore, enterprise platform application 810 can cooperate with e-mail manager 808 to communicate various enterprise management/sales/project data to one or more cooperating parties (e.g., players, participating users (sales personnel), etc.). Virtual sales assistant 824 can cooperate with one or more of enterprise management and sales platform 802 to operatively generate data representative of aggregated action items for one or more projects for communication to one or more cooperating parties (as described by FIG. 18).

Furthermore, enterprise management and sales platform 802 can cooperate with logger component 830 and data access manager 828 (which in turn can cooperate with data store manager 826) to track usage of enterprise management and sale platform 802 and to retrieve/store various enterprise management/sales/project data with one or more cooperating data stores (not shown). Similarly, advertisement computing application 832 can cooperate with logger component 850 and data access manager 848 (which in turn can cooperate with data store manager 846) to track usage of advertisement computing platform 832 (e.g., usage of one or more selected advertisements) and to retrieve/store various advertisement data with one or more cooperating data stores (not shown).

It is appreciated that although the cooperation of various components have been described by FIG. 8 (e.g., arrowed lines) that such description is merely illustrative as the herein described systems can comprise various components cooperating in various ways to provide one or more of the enterprise management and sales operations described herein.

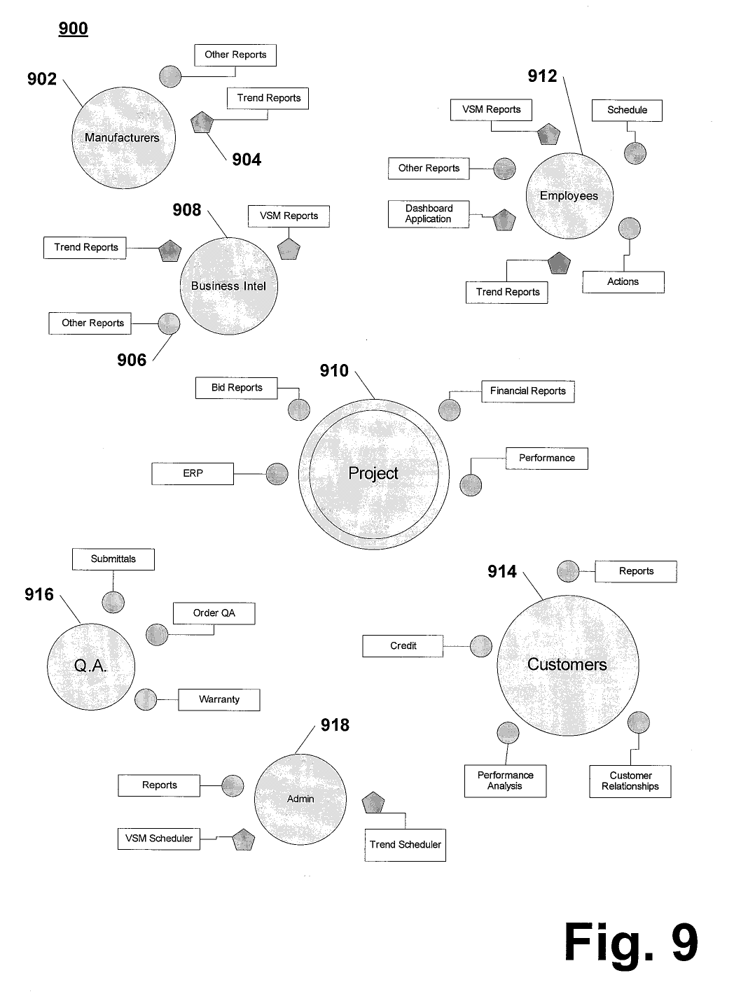

FIG. 9 depicts an exemplary screen shot of an exemplary user interface 900 operable to be displayed and navigated on an exemplary computing application (e.g., a web browser). As is shown in FIG. 9, exemplary user interface 900 comprises various core spheres including project sphere 910, manufacturers sphere 902, business intelligence sphere 908, employees sphere 912, customers sphere 914, administration sphere 918, and quality assurance sphere 916. Additionally, user exemplary user interface 900 comprises various satellites 904 and 906.

In an illustrative implementation, a core sphere (902, 910, 912, 914, 916, and 918) can represent one or more desired data management operations/functions/data performed by, for example, exemplary enterprise management and sales platform 420 of FIG. 4. In the illustrative implementation, a core sphere (902, 910, 912, 914, 916, and 918) can be surrounded by one or more satellites that are related to the core sphere. In an illustrative operation, a core sphere can typically launch a core form (e.g., 906) with all the associated sub-forms (e.g., a satellite form—not shown). In an illustrative operation, core spheres (902, 910, 912, 914, 916, and 918) and the satellites can operatively act as links to engage one or more portions of exemplary enterprise/sales/advertising application 437 of FIG. 4. Illustratively, a cooperating party can engage the graphical representation of a core sphere and/or satellite to obtain desired enterprise management and/or sales data.

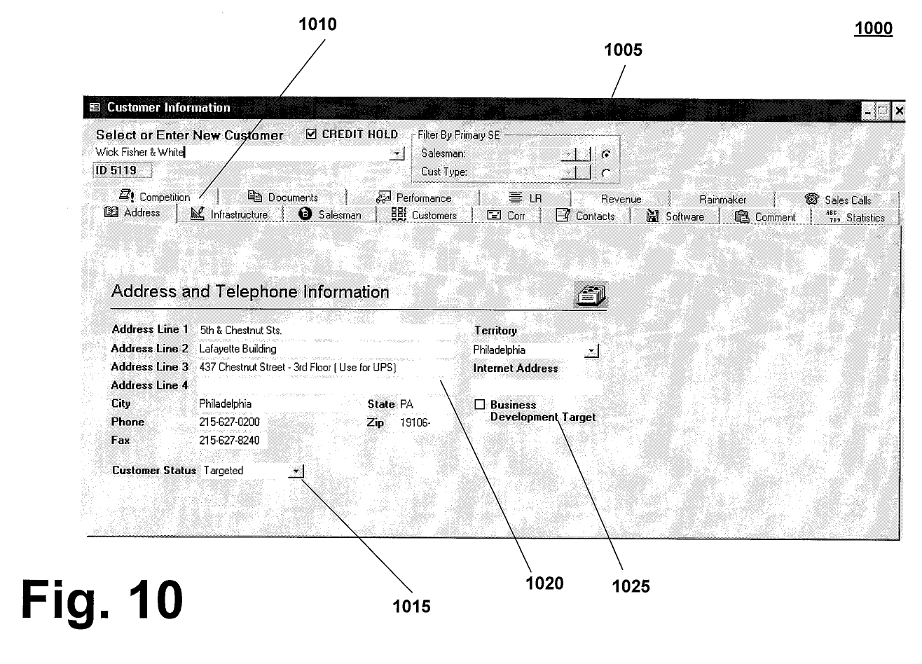

FIG. 10 depicts an exemplary screen shot 1000 of a dialog box 1005 operable to be displayed and navigated on an exemplary computing application (e.g., a web browser). As is shown in FIG. 10, exemplary dialog box 1005 can comprises various data display, manipulation, navigation, and modification controls 1010, 1015, 1020, and 1025 that can be used to display, manipulate, navigate, and/or modify various enterprise management sales data. In an illustrative implementation, exemplary dialog box 1005 can comprise customer data for an exemplary project that can be initiated through the engagement of customers sphere 914 user interface component of FIG. 9. As illustrated, exemplary dialog box 1005 provides an interface to add and edit information regarding customers. In an illustrative embodiment, a customer may be a party or player as described above in connection with one or more projects.

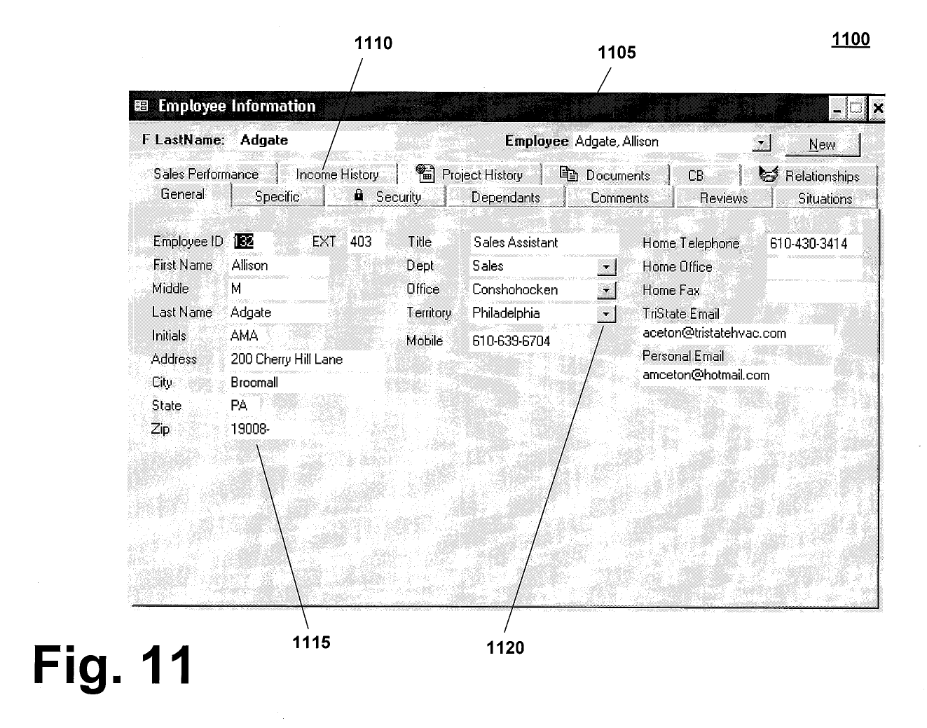

FIG. 11 depicts an exemplary screen shot 1100 of a dialog box 1105 operable to be displayed and navigated on an exemplary computing application (e.g., a web browser). As is shown in FIG. 11, exemplary dialog box 1105 can comprises various data display, manipulation, navigation, and modification controls 1110, 1115, and 1120 that can be used to display, manipulate, navigate, and/or modify various enterprise management sales data. In an illustrative implementation, exemplary dialog box 1105 can comprise employee data for a party or entity associated with an exemplary project. The dialog box may be initiated, for example, through the engagement of employees sphere 912 user interface component of FIG. 9. As illustrated in dialog box 1105, various types of information may be collected for employees including, for example, general information about the employee and information relevant to the organization. Dialog box 1105 further indicates that it is possible to identify relationships with customers and players that the particular employee is responsible for maintaining.

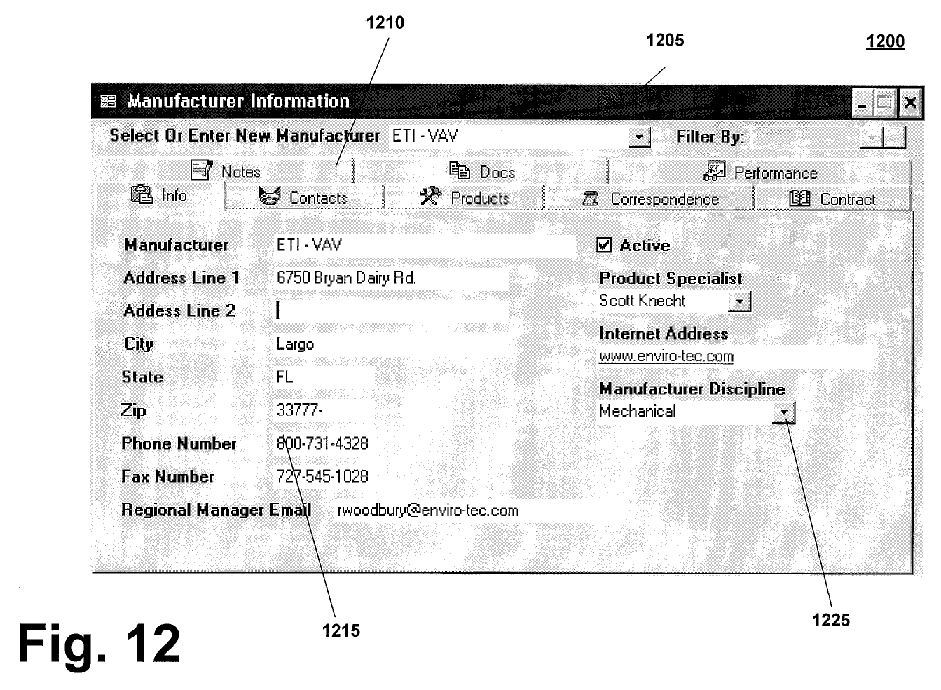

FIG. 12 depicts an exemplary screen shot 1200 of a dialog box 1205 operable to be displayed and navigated on an exemplary computing application (e.g., a web browser). As is shown in FIG. 12, exemplary dialog box 1205 can comprises various data display, manipulation, navigation, and modification controls 1210, 1215, and 1220 that can be used to display, manipulate, navigate, and/or modify various enterprise management sales data. In an illustrative implementation, exemplary dialog box 1205 can comprise manufacturers data for an exemplary project that can be initiated through the engagement of manufacturers sphere 902 user interface component of FIG. 9. As illustrated in dialog box 1205, various types of information may be collected for manufacturers including, for example, general information about the manufacturer as well information about tracking contacts with the manufacturer.

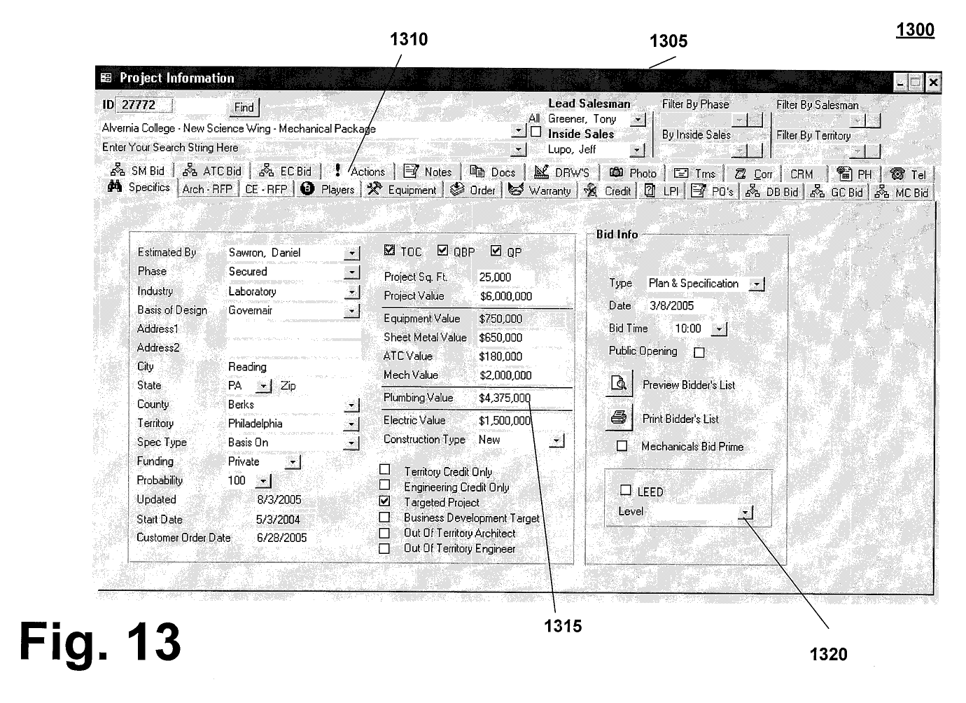

FIG. 13 depicts an exemplary screen shot 1300 of a dialog box 1305 operable to be displayed and navigated on an exemplary computing application (e.g., a web browser). As is shown in FIG. 13, exemplary dialog box 1305 can comprises various data display, manipulation, navigation, and modification controls 1310, 1315, and 1320 that can be used to display, manipulate, navigate, and/or modify various enterprise management sales data. In an illustrative implementation, exemplary dialog box 1305 can comprise project data for an exemplary project that can be initiated through the engagement of customers spheres 910 user interface component of FIG. 9. As shown, dialog box 1305 provides a capability to add and update information regarding a project. The information may comprise, for example, the location and financial aspects of the project. As indicated by the tabs on dialog box 1305, operators of the application may also provide for receiving request for proposal (RFP) information, information regarding bids placed for the project, and drawings and photographs relating to the project. Furthermore, dialog box 1305 provides a the capability to specify players that are associated with the project. Moreover, actions that are identified using a party relationship strength analysis as discussed herein may also be accessed from dialog box 1305.

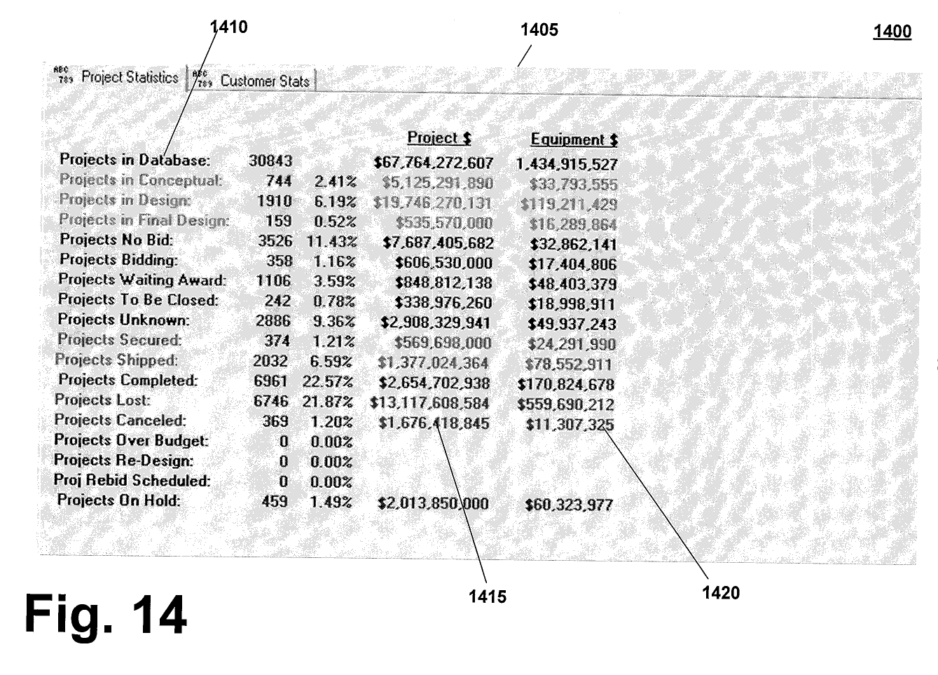

FIG. 14 depicts an exemplary screen shot 1400 of a exemplary report 1405 operable to be displayed and navigated on an exemplary computing application (e.g., a web browser). As is shown in FIG. 14, exemplary report 1405 can comprises various data 1410, 1415, and 1420 that can be displayed, manipulated, navigated, and/or modified. In an illustrative implementation, exemplary report 1405 can comprise project data for an exemplary project that can be displayed according to one or more selected filters including project phase, total project value, and total project equipment value. In an illustrative operation, the generation of exemplary report 1405 can be initiated through the engagement of one or more satellite spheres user interface 900 of FIG. 9 and can be illustrative processed by one or more enterprise management and sales platform components including but not limited to sales dashboard 812, trend reporter 814, performance analyzer 816, and virtual sales manager 818 of FIG. 8.

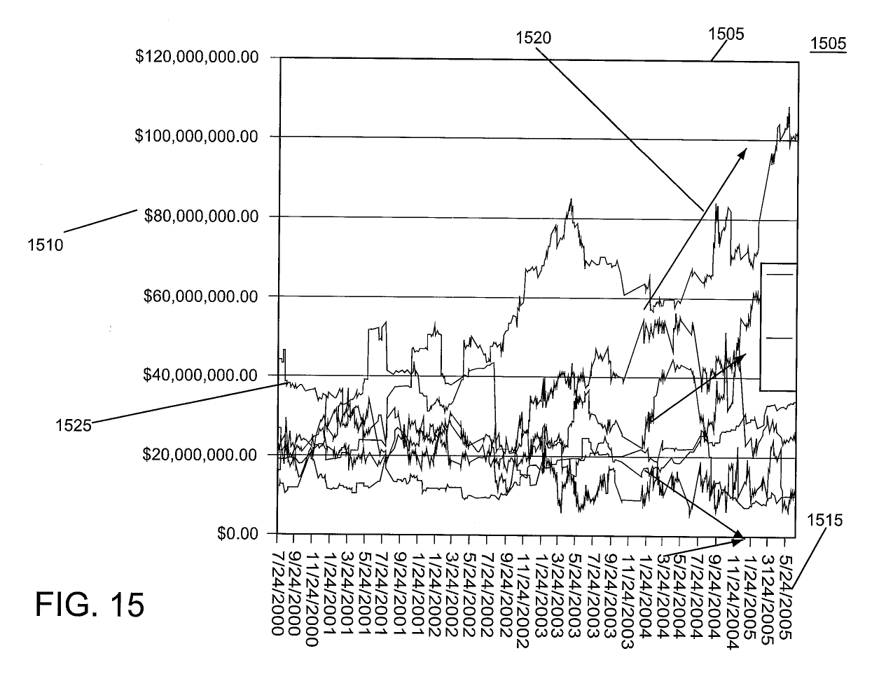

FIG. 15 depicts an exemplary screen shot 1500 of a exemplary trending report 1505 operable to be displayed and navigated on an exemplary computing application (e.g., a web browser). As is shown in FIG. 15, exemplary trending report 1505 can comprises various graphical data 1520 and 1525, representative of various enterprise metrics including but not limited to project value 1510 over selected period of time 1515, that can be displayed, manipulated, navigated, and/or modified. In an illustrative implementation, exemplary trending report 1505 can comprise project data for an exemplary project that can be displayed according to one or more selected filters including project phase, total project value, selected time period, and total project equipment value. In an illustrative operation, the generation of exemplary trending report 1505 can be initiated through the engagement of one or more satellite spheres user interface 900 of FIG. 9 and can be illustrative processed by one or more enterprise management and sales platform components including but not limited to sales dashboard 812, trend reporter 814, performance analyzer 816, and virtual sales manager 818 of FIG. 8.

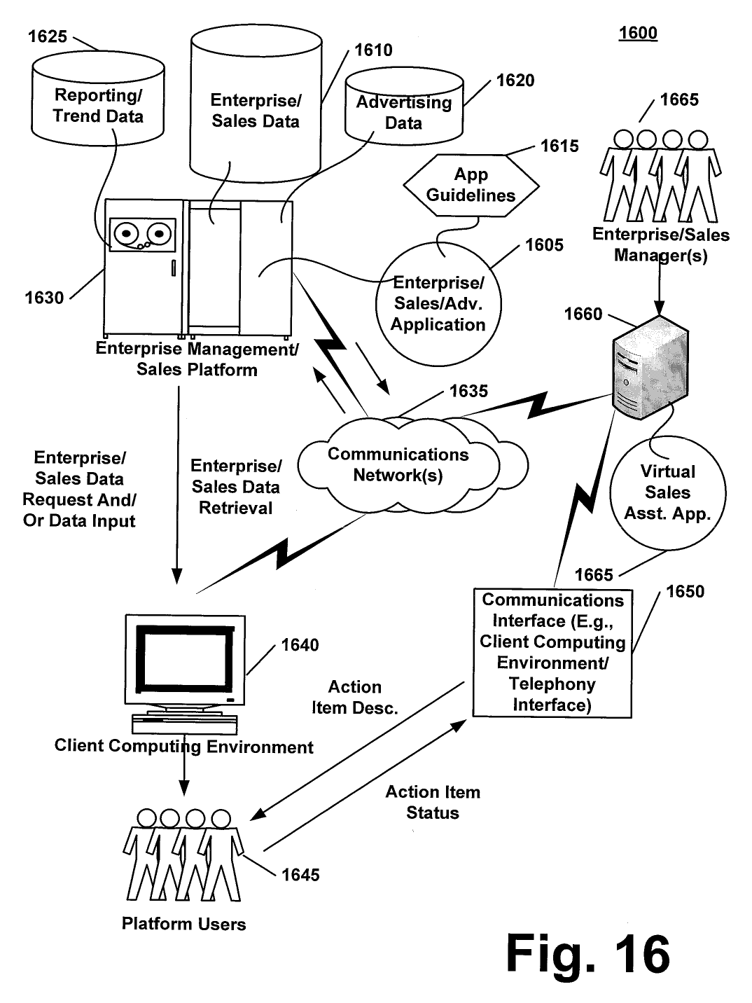

FIG. 16 provides a view of an illustrative implementation of an exemplary enterprise management environment 1600 performing one or more virtual sales assistant operations. As is shown in FIG. 16, enterprise management/sales platform 1630 has access to enterprise/sales data 1610, reporting/trend data 1625, and advertising data 1620. Enterprise/sales/advertising application 1605 can be, in an illustrative implementation, a software application that executes on enterprise management/sales platform 1630 and can apply enterprise management/sales application guidelines 1615 to various data including but not limited to enterprise/sales data 1610, reporting/trend data 1625, and advertising data 1620. In an exemplary embodiment, enterprise management/sales application guidelines 1615 may reflect one or more player relationships as described in FIG. 5. In an alternate embodiment, one or more of the various data that enterprise management/sales platform 1630 utilized can be stored separately from enterprise management/sales platform 1630.

Enterprise management/sales platform 1630 is communicatively coupled to client computing environment 1640 (e.g., operative by one or more participating users 1640—e.g., enterprise sales personnel) via communications network 1635. In an illustrative embodiment, communications network 1635 may comprise fixed-wire and/or wireless intranets, extranets, local area networks, wide area networks, and the Internet.

In an illustrative operation, one or more participating users 1645 (e.g., enterprise sales personnel) can request and/or input various enterprise/sales data to enterprise management/sales platform 1630 using client computing environment 1640 over communications network 1635. Responsive to the request to retrieve/store enterprise/sales data, enterprise management/sales data can execute enterprise/sales/advertising application 1605 applying one or more enterprise/sales/advertising application guidelines 1615 to retrieve/store selected enterprise/sales data and communicate enterprise/sales data to client computing environment 1640 over communications network 1635 for display, navigation, storage, appending, modification, etc. by one or more participating users 1645.

Further, as is shown in FIG. 4, enterprise management environment 1600 can comprise virtual sales assistant computing environment 1660 communicatively coupled to enterprise management/sales platform 1630 over communications network 1635, and customer computing environment 1640 that is communicatively coupled to enterprise management/sales platform 1630 over communications network 1635. In the illustrative implementation, enterprise/sales/advertising application 1605 executing on enterprise management/sales platform 1630 can cooperate with virtual sales assistant computing environment 1660 executing exemplary virtual sales assistant application 1665 over communications network 1635 to receive data representative of one or more generated action items lists for processing to, illustratively, be communicated to one or more platform users 1645 using communications interface (e.g., interactive voice recognition) 1650. In the illustrative implementation, virtual sales assistant application 1665 can comprise one or more instructions to cooperate with enterprise/sales/advertising application 1605 retrieve various enterprise/sales data 1610 to generate one or more action items lists.

In an illustrative operation, virtual sales assistant application 1665 can periodically (e.g., according to a selected frequency) cooperate with enterprise/sales/advertising application 1605 to retrieve selected enterprise/sales data 1610 to generate one or more action items lists for communication to one or more platform users 1645 using communications interface 1650. For example, application 1665 may periodically download an action item list corresponding to opportunities identified using a player relationship strength analysis as discussed herein. The action item listing may be prioritized according to any desired logic. The action item list may be communicated through any interface that is suitable including a web interface on a personal digital assistant. In the illustrative operation, virtual sales assistant application 1665 can communicate the generated one or more action items list using an exemplary interactive voice recognition interface (e.g., automated telephonic attendant) that can communicate a description of one or more action items of the one or more generated action items lists (and/or to automatically generate action items based on one or more selected criteria including but not limited to the project phase) to a selected platform user 1645 (e.g., virtual sales assistant application can retrieve project assignments for an enterprise sales team and generate individualized action items lists for each of the sales team members based on the sales team member's project assignment, project phase, or other criteria) and prompt the one or more platform users 1645 to input data through the exemplary communications interface 1650 of the status of the communicated action items. In the illustrative operation, virtual sales assistant application 1660 can receive through communications interface 1650 data representative of action items status for subsequent processing (e.g., logging, generating performance reports, trending, etc.) and communication to one or more enterprise sales managers 1665.

FIG. 17 depicts a flow diagram of exemplary method 1700 that may be performed by illustrative enterprise management/sales platform as described herein including in connection with FIGS. 3, 7, 8, and 16 using a player relationship strength analysis to identify project opportunities. At block 1710 one or more player relationships can be defined. For example, information regarding player relationships may be input into the system defining player relationships such as discussed above in connection with FIGS. 5 and 6. The information may comprise an identification of the relationships between parties and one or more values identifying the strength of the relationship or influence of one party on another. The information may be entered using one or more user interface screens, input via a script, or by any other suitable means. The information is stored in memory and may be stored, for example, at enterprise/sales database 410.

At block 1720, data representative of one or more players and/or sales/project opportunities can be received (e.g., by an exemplary enterprise management/sales platform). Information regarding projects may be received, for example, using one or more dialog screens similar to that discussed in connection with FIG. 13. All information associated with the project is entered including, for example, information regarding: the players and persons or contacts at the players associated with the particular project are entered; the phase of the project; the schedule for the project; the status state of the project; etc. The information may be stored in memory including, for example, at enterprise/sales database 410.

The received data can then be associated with one or more sales/project opportunities (and/or one or more existing projects) at block 1730. Thus, the player data that is received is integrated with other information gathered for the various projects that have been entered into the system. Likewise any player relationship data that is integrated with the existing project data.

At block 1740, the received data and any existing project, player, and relationship data is utilized to track one or more stages of one or more sales/project opportunities and to generate one or more enterprise/sales/project deliverables (e.g., purchase orders, invoices, correspondence, contact documents, accounting spreadsheets, e-mail communications, various sales/project reports, etc.). More particularly, at block 1740 a player relationship strength analysis is performed on the project data to identify opportunities such as for sales and to identify action items that should be taken to enhance the possibility of a favorable outcome to those opportunities as discussed above. For example, the player relationship data might indicate a consulting engineer 545 has a relationship with architect 530 and provides advice to architect 530 as to the types of equipment that are specified for a project. Accordingly, it might be of interest to manufacturing representatives 550 to communicate with consulting engineer 545 so as to attempt to influence engineer 545 to suggest to architect 530 to use the manufacturers materials on the project. At step 1740, the exemplary systems identify the opportunity for the manufacturing representative 550 to enhance the possibility that their equipment might be used on the job by interfacing with the consulting engineer.

More particularly, the step of using data to generate a report outlining project opportunities may comprise processing the data regarding one or more opportunities and the data regarding one or more parties associated with the one or more opportunities to identify parties associated with each of the one or more opportunities. Thereafter, the relationships between the identified parties are identified for each of the one or more opportunities and a relationship strength value is identified for each of the identified relationships. The identified relationship strength for each of the identified relationships is then used to determine data that is to be presented for each of the one or more opportunities. For example, the data may comprise action items associated with each of the opportunities.

Furthermore, at step 1740, the system may also include in its logic for identifying opportunities the phase and status state of the project as discussed above in connection with FIG. 6. For example, when a project is in the design phase 630, there is an opportunity for manufacturing representatives 550 to influence consulting engineers 545 who might influence the architect 530 to include a particular manufacturers devices in the job specifications. However, when the project moves beyond the design and final design 635 phases, there is little opportunity for the consulting engineer 545 to influence the design of the project because the design is complete. But, when the project has reached the bidding phase, the opportunity is ripe for attempting to influence the construction managers 560 and owner's representative 555 as to the selection of a general contractor 570. The illustrative systems and methods capture the logic associated with the impact of changes in phases and status states on the opportunities to influence decision making.

At step 1750, access to selected sales/project data is provided to one or more players according to the methods described herein. Generally, the opportunities identified by the system may be presented in any form that is suitable including, for example via a report that is generated upon request. The report may comprise, for example, a listing of action items that should be attended to in order to pursue the opportunities. For example, the action items may list contacts at parties who should contacted in order to pursue the particular opportunity. The listing of action items may be prioritized by the system based upon any type of suitable logic including, for example, the opportunities that are closest to generating revenue or the opportunities that have the greatest possible revenue.

The data outlining opportunities that are identified using a player relationship strength analysis may be sent via email or any other messaging system or technology. The information may be retrieved using a link that is emailed to the user. Furthermore, the data may be presented using a virtual data assistant as described in connection with FIG. 16 which may use, for example, an interactive voice recognition interface. The information that is made available to the user may include one or more advertisements that are selected and integrated into the opportunity data as described herein including, for example, in connection with the discussion of FIGS. 4, 7, 19, and 20.

Access to the selected sales/project data by one or more players having been provided access rights is tracked at block 1760. The tracking data may be subsequently used to generate further reports.

The systems and methods disclosed herein are data driven and are continuously updated as the data in the system changes. FIG. 18 illustrates this aspect of the disclosed systems and methods. FIG. 18 depicts a flow diagram of exemplary method 1800 that may be performed by illustrative enterprise management/sales platform as described herein including, for example, in connection with FIG. 16. At block 1810 data representative of one or more sales/project opportunities can be retrieved from a cooperating data store. Processing then proceeds to block 1820 where the retrieved sales/project data can be categorized according to one or more sales/project personnel assignments to generate one or more sales/project periodic action items list having one or more action items for one or more sales/project personnel. The periodically generated action items list can then be electronically communicated at block 1830 to one or more sales/project personnel using a selected communications interface (e.g., automated interactive voice recognition platform).

From there, processing proceeds to block 1840 where data representative of the status of one or more action items from the generated periodic sales/project action item list for the one or more sales/project personnel is received (e.g., by exemplary enterprise management/sales platform). For example, a user of the system may input information indicating a particular project has moved from the design phase as discussed in connection with FIG. 5 to the bidding phase. Processing then proceeds to block 1850 where the generated periodic sales/project action list is updated using the received status data (i.e., received at block 1840). For example, those action items that were appropriate for a project in the design phase may no longer appear on the action item list, while new items associated with the bidding phase are included. One or more reports can then be generated at block 160 having data representative of the generated periodic sales/project action items status to develop one or more selected metrics (e.g., efficiency) regarding the action items. Processing reverts back to block 1810 and proceeds from there.

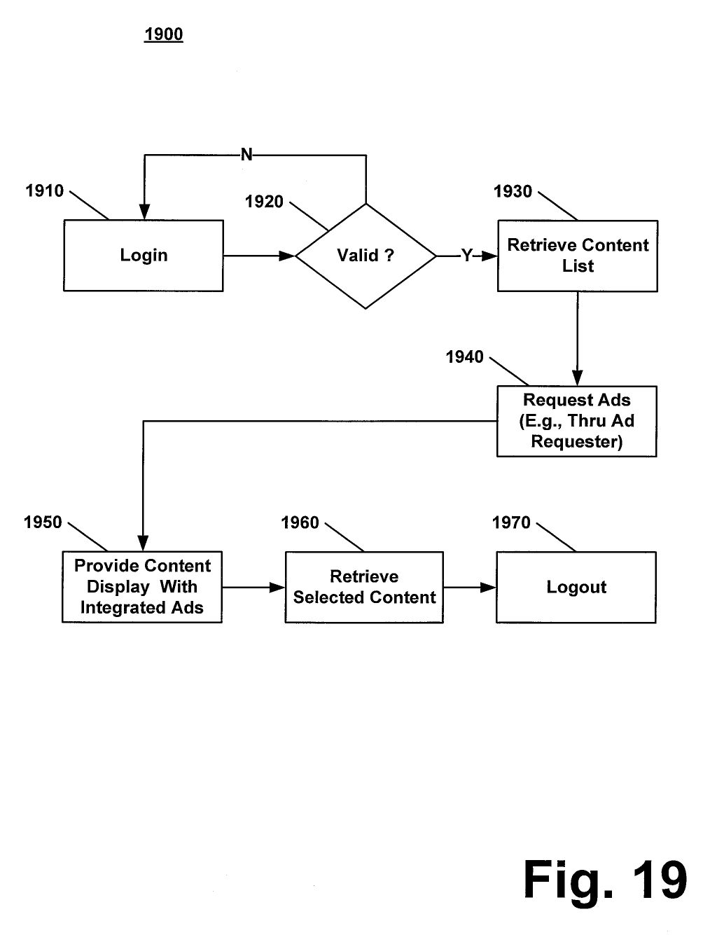

FIG. 19 depicts a flow diagram of exemplary method 1900 that may be performed by illustrative enterprise management/sales platform as described herein including, for example, in connection with FIG. 4. At block 1910, login credentials are received by a cooperating component desirous of obtaining access to data from exemplary enterprise management and sales platform of FIG. 4. A check is performed at block 1920 to determine if the login credentials are valid. If the check at block 1920 indicates that the login credentials are not valid, processing reverts to block 1910.

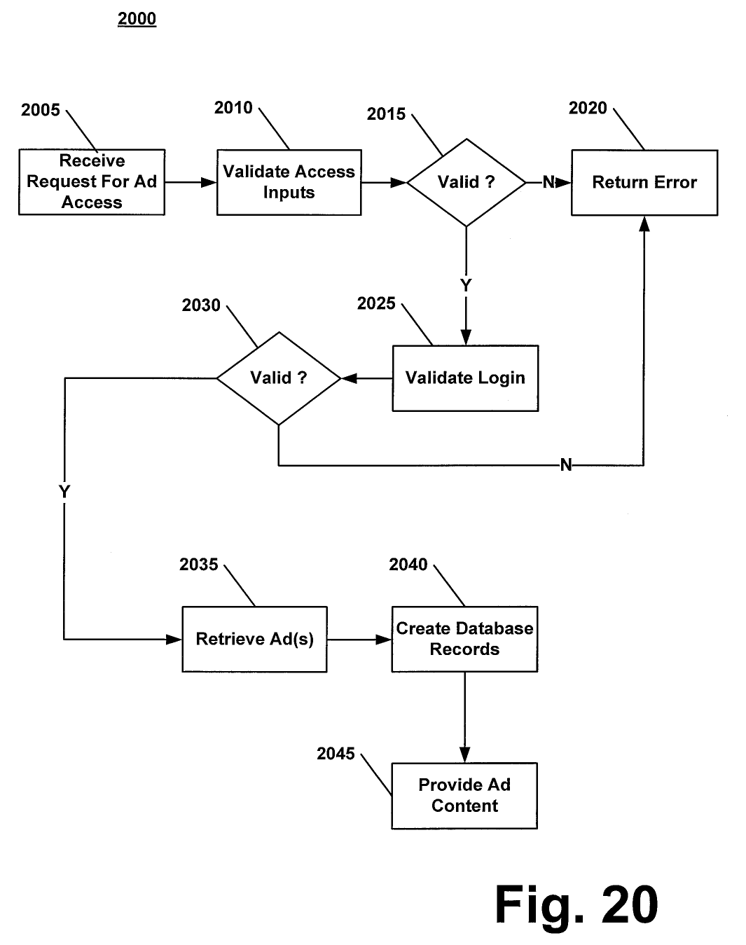

However, if the check at block 1920 indicates that the login credentials are valid, processing proceeds to block 1930 where content/data list is retrieved. The content made available to the user may include, for example, information regarding project opportunities for the particular user Processing then proceeds to block 1940 where one or more advertisements can be requested and received as described herein including, for example in connection with FIG. 20. For example, the characteristics of the user of the system, which are stored in or accessible to the system, are used to identify advertising content for the particular user. The advertising content may be directed toward individuals with interests and backgrounds similar to that of the user as discussed above in connection with FIG. 7. Content having integrated one or more advertisements (e.g., that can be selected based in part on one or more characteristics of the requesting party) can then be provided (e.g., for display, navigation, download, etc.) at block 1950. The selected content with advertisements can then be retrieved at block 1960 by the system user. For example, the user may click on a link in an email to download the requested content along with advertisements selected according to the user's characterisitics. Processing then proceeds to block 1970 where a logout operation can be performed.

FIG. 20 depicts a flow diagram of exemplary method 2000 that may be performed by illustrative enterprise management/sales platform of FIG. 4. As shown, at block 2005, a request can be received for access to one or more advertisements. Processing then proceeds to block 2010 where access inputs are validated. A check is then performed at block 2015 to determine if the access inputs are valid. If the check at block 2015 indicates that the access inputs are not valid, processing proceeds to block 2020 where an error is returned (e.g., to the cooperating component requesting access and/or providing the access advertisement access inputs) and processing then terminates. However, if the check at block 2015 indicates that the access inputs are valid, processing proceeds to block 2025 where login credentials are validated (e.g., login credentials of a participating party having been provided access to data stored on and/or generated by exemplary enterprise management/sales platform of FIG. 4).

A check is performed at block 2030 to determine if the login credentials are valid. If the check at block 2030 indicates that the login credentials are not valid processing proceeds to block 2020 where an error is returned and then processing terminates. However, if the check at block 2030 indicates that the login credentials are valid, processing proceeds to block 2035 where one or more advertisements can be retrieved (e.g., using the received access inputs and the login credentials). Processing then proceeds to block 2040 where one or more database records are created to track retrieval/delivery of the advertisements. From there, processing proceeds to block 2045 where the advertisement content is provided (e.g., provided to the cooperating component—participating party associated with the login credentials provided at block 2035).

Thus, Applicants have disclosed systems and methods for managing enterprise data. In an exemplary embodiment, content is selected for distribution, in part, based upon the management of enterprise data according to a player chain strength paradigm. The strength of relationships between players associated with a project is used to identify opportunities to, for example, make sales. Data reporting enterprise data including identification of opportunities may be reported in the form of an action item list that is prioritized according to a desired logic. The information may be communicated using a telephone interface that may have, for example, a voice prompt interface. Furthermore, advertisements selected based upon characteristics of the user of the system may be reported with the enterprise data including a listing of project opportunities.

The embodiments disclosed herein are for exemplary purposes only. Additional embodiments that may not be explicitly disclosed fall within the contemplated embodiments. For example, any suitable device may be used to collect environment data and display content. Furthermore, any type of environment condition data may be collected and used in the determination of content to be delivered.

The methods and adaptations of the disclosed systems that are described herein can be implemented by computer-executable instructions stored on one or more computer-readable media or conveyed by a signal of any suitable type. The methods can be implemented at least in part manually. The steps of the methods can be implemented by software or combinations of software and hardware and in any of the ways described above. The computer-executable instructions can be the same process executing on a single or a plurality of microprocessors or multiple processes executing on a single or a plurality of microprocessors. The methods can be repeated any number of times as needed and the steps of the methods can be performed in any suitable order.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the subject matter described herein can be practiced with most any suitable computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing some of the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

Moreover, it is to be appreciated that various aspects as described herein can be implemented on portable computing devices and other aspects can be implemented across distributed computing platforms. Likewise, various aspects as described herein can be implemented as a set of services.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both non-wireless and wireless computer environments), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus can also be considered to be implemented as a computer-readable storage medium, configured with a computer program, where the storage medium so configured causes a computer to operate in a specific and predefined manner.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

What is claimed:

1. A system, comprising:
a data store comprising data regarding one or more opportunities and data regarding one or more parties associated with the one or more opportunities; and
a computing system communicatively coupled with the data store, the computing system comprising computer executable instructions for performing the following:
processing the data regarding one or more opportunities and the data regarding one or more parties associated with the one or more opportunities to identify parties associated with each of the one or more opportunities;
identifying relationships between the identified parties for each of the one or more opportunities, and for each of the identified relationships identifying a relationship strength; and
employing the identified relationship strength for each of the identified relationships to determine for presentation data regarding each of the one or more opportunities.

2. The system of claim 1, wherein employing the identified relationship strength for each of the identified relationships to determine for presentation data comprises applying a player chain strength paradigm to determine data for presentation.

3. The system of claim 1, wherein the computing system further comprises one or more computer executable instructions for providing access to one or more parties to the data regarding each of the one or more opportunities.

4. The system of claim 1, wherein the data regarding one or more opportunities comprises data regarding one or more sales opportunities.

5. The system of claim 1, wherein the data regarding one or more opportunities comprises data regarding sales opportunities associated with construction projects.

6. The system of claim 3, wherein the data store comprises data representative of one or more advertisements.

7. The system of claim 4, wherein the computing system further comprises one or more instructions to select one or more advertisements to integrate with the data for presentation regarding each of the one or more opportunities.

8. The system of claim 7, wherein the one or more instructions to select one or more advertisements comprises one or more instructions to select advertisements according to a selected player/advertisement selection paradigm.

9. The system of claim 7, wherein the one or more instructions to select one or more advertisements to integrate with the data for presentation comprises one or more instructions to select an advertisement based at least in part on one or more characteristics of the parties having been provided access to the data for presentation regarding each of the one or more opportunities.

10. The system of claim 9, wherein the computing system further comprises one or more computer executable instructions to communicate data regarding the one or more opportunities having integrated therein the selected one or more advertisements to at least one of parties having been provided access to the data regarding the one or more opportunities.

11. The system of claim 10, wherein the computing system further comprises one or more instructions to track the usage of the one or more advertisements.

12. The system of claim 1, wherein employing the identified relationship strength for each of the identified relationships to determine for presentation data regarding each of the one or more opportunities comprises generating a list of one or more action items for each of the one or more opportunities.

13. The system of claim 12, wherein employing the identified relationship strength for each of the identified relationships to determine for presentation data regarding each of the one or more opportunities further comprises communicating the generated list of one or more action items for the one or more opportunities to a participating user through a selected communication interface.

14. The system of claim 13, wherein the selected communications interface comprises an interactive voice recognition platform operative to receive data inputs from the participating user representative of the status of the one or more action items for the one or more opportunities.

15. The system of claim 14, further comprising one or more instructions to track the received data representative of the status of the one or more action items for the one or more opportunities.

16. The system of claim 2, wherein the player strength chain paradigm comprises data representative of one or more participating parties to the one or more opportunities.

17. The system of claim 16, wherein the one or more participating parties comprises one or more of a property owner, an architect, consulting engineer, manufacturer representatives, acoustic engineer, LEEDs engineer, project lender, leasing agent, owner's representative, construction manager, general contractor, sub contractor, and bonding agent.

18. The system of claim 17, further comprising one or more instructions to track the strength of the relationship between the one or more participating parties.

19. The system of claim 18, further comprising one or more instructions to categorize the one or more participating parties according to one or more categories using one or more characteristics of the one or more opportunities,
wherein the categories comprise one or more of design and construction categories.

20. The system of claim 1, further comprising one or more instructions to track the one or more opportunities according to one or more selected phases.

21. The system of claim 20, wherein the project phases comprises one or more of conceptual, design, final design, bidding, waiting award, to be closed, secured, shipped, and completed.

22. A computer implemented method for managing project opportunities, comprising:
receiving data representative of one or more project opportunities;
executing one or more instructions to process data utilizing the strength of one or more relationships between one or more participating parties of one or more project opportunities; and
generating one or more documents comprising processed data representative of the one or more project opportunities.

23. The method of claim 22, wherein receiving data representative of one or more project opportunities comprises receiving data representative of one or more sales opportunities.

24. The method as recited in claim 22, further comprising providing access to one or more participating parties to data representative of one or more project opportunities

25. The method as recited in claim 24, further comprising selecting one or advertisements to integrate with the data representative of one or more project opportunities according to a selected player/advertisement selection paradigm.

26. The method as recited in claim 25, further comprising selecting an advertisement based in part on one or more characteristics of the one or more participating parties having been provided access to the data representative of the one or more project opportunities.

27. The method as recited in claim 26, further comprising communicating data representative the one or more project opportunities having integrated therein one or more selected advertisements selected according to the selected player/advertisement selection paradigm to the one or more participating parties.

28. The method as recited in claim 27, further comprising generating a list of one or more action items for one or more project opportunities using at least one of enterprise management data or sales data.

29. The method as recited in claim 28, further comprising communicating the generated list of one or more action items for the one or more project opportunities to a participating user through a selected communication interface,
wherein the selected communications interface comprises an interactive voice recognition platform operative to receive data inputs from the participating user representative of the status of the one or more action items for the one or more project opportunities.

30. A computer readable medium comprising computer readable instructions to instruct a computer to perform a method comprising:
receiving data representative of one or more sales and/or project opportunities according to a selected player chain strength paradigm,
applying the player chain strength paradigm comprising data representative of processing data the strength of one or more relationships between one or more participating parties of one or more sales and/or project opportunities; and
generating one or more enterprise management and/or sales documents comprising processed data representative of the one or more sales and/or project opportunities
